(19) United States
(12) Patent Application Publication
(10) Pub. No.: US 2008/0158265 A1
(43) Pub. Date: Jul. 3, 2008

(54) Method and device for multi-grayscale display

(75) Inventors: Yutaka Chiaki, Yokohama (JP); Naoki Itokawa, Yokohama (JP); Yoshiaki Takada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Fujitsu Hitachi Plasma Display Limited, Miyazaki (JP)

(21) Appl. No.: 11/999,100

(22) Filed: Dec. 3, 2007

(30) Foreign Application Priority Data
Dec. 4, 2006 (JP) 2006-326874

(51) Int. Cl. G09G 5/10

(52) U.S. Cl. 345/690

(57) ABSTRACT

A multi-grayscale display device to appropriately control brightness of a display (screen) and power according to the content of a picture while preventing deterioration of image quality of a picture, so that both of these performances are improved. In a multi-grayscale processing unit of the display device (PDP device), in a subfield (SF) driving control, the number of pixels of low grayscales in an image of an input picture signal is detected and determined by an image number detection unit, and accordingly, a selection signal to switch one from outputs of a plural types of SF conversions of an SF conversion unit is determined and outputted by a switching unit. In the control, an SF conversion in which the number of rest SF becomes large as the number of pixels of low grayscales becomes small selected.

### CROSS-REFERENCE TO RELATED APPLICATION

The present application claims priority from Japanese Patent Application No. JP 2006-326874 filed on Dec. 4, 2006, the content of which is hereby incorporated by reference into this application.

### BACKGROUND OF THE INVENTION

The present invention relates to a technique for a multi-grayscale display device (digital display device) for displaying a multi-grayscale picture (moving image) on a display panel. More particularly, the present invention relates to a technique for controlling a luminance of picture and power in a display driving control using a subfield method in a display device (plasma display device: PDP device) and the like comprising a plasma display panel (PDP).

In recent years, a demand for thin-type display devices has been growing along with the display devices becoming larger, and so various types of thin-type display devices are provided. For example, a Matrix Panel that displays with digital signals as they are, i.e., gas discharge panels such as PDP, DMD (Digital Micromirror Device), EL display device, fluorescent display tube, liquid crystal display device, and the like have been provided. From among these thin-type display devices, the gas discharge panels such as the PDD has been put into practical use as a HDTV (high definition TV) display device of a large sized direct-view type due to its easiness for enlarging the size of the screen, good display quality from being a self-emission type, quick response speed and the like.

In the above described display devices, for example, in the PDP device, a multi-grayscale moving image is displayed on the panel by using the subfield method based on an input image (picture) signal. In the subfield method, one field (frame) serving as an image display unit to the panel screen (display area) is divided into a plurality (taken as N) of subfields (subframes) serving as temporal emission blocks, and each of these blocks is configured to be controlled with a predetermined weight of luminance (brightness) by a light emitting period for grayscale expression. In this configuration, by combining and selecting a state of emitting light (On) or not emitting light (Off) of the subfield per display cell of the field (subfield conversion), the display of multi grayscale is performed. Each subfield in the field includes an address pulse to select a cell and a plurality of sustain pulses for the discharge emission of the cell.

In the multi-grayscale display device controlling On/Off of the plurality of subfields, it is desired to achieve both performances of reduction of power consumption and improvement of brightness (luminance) relative to the picture display, which are generally contradictory.

With regard to the above, as a system for reducing power consumption and improving screen brightness in conventional techniques, a system has been proposed in which an average level of the brightness (average picture (luminance) level: APL) of the screen is detected, and a peak level of the brightness and the power consumption of the image are detected, thereby adjusting the number (N) of subfields in the field and the total number of driving pulses or the total driving pulse period (length of the sustain period and the like) so that the screen brightness, the number of grayscale levels and the power consumption are controlled, and pseudo contour (false contour) noise of moving image is reduced.

Japanese Patent Application Laid-Open Publication No. 11-231825 discloses the above described technique example. This is an example of changing the number (N) of subfields of a field according to an input image (input image signal).

### SUMMARY OF THE INVENTION

In the system in which power consumption is reduced and screen brightness is improved in the conventional technique, even when APL of the image is detected, there exist various distribution situations of data level (signal value) depending on the image and thus the multi-grayscale expressive power often reduces. For example, even the case where the APL of image is at the same 50%, there are a case of an image whose levels are all close to 50%, and a case of an image in which the number of pixels with levels close to 0% is 50% and the number of pixels with levels close to 100% is 50%. In the latter case, when the number (N) of subfields is reduced by a field driving control according to the APL (especially when the subfields of a small weight are eliminated), the number of grayscale levels (the number of steps) is reduced, thereby reducing the expressive power of low grayscale.

Further, as other system of driving control, it is also possible that the number (N) of sub-fields is reduced (especially when the sub-fields of large weight are eliminated), so that the number of grayscale levels (the number of steps) is made the same. However, in this case, since Off-subfields are increased, the pseudo contour noise is strengthened, and thus it invites a deterioration of the image quality.

Further, when the number (N) of subfields changes in every field by the driving control, a temporal position of the weighted center of emission shifts. This causes a user to recognize a switching shock, and by that much, the image quality is deteriorated.

The present invention has been made in view of the above described problems, and an object of the invention is to provide a technique which relates to a multi grayscale display device. While preventing the deterioration of image quality of an image, the brightness (screen) and the power of the display are appropriately controlled according to the content of the picture so that both of these performances can be improved. Further, with respect to the prevention of image quality deterioration, another object of the present invention is to provide a technique capable of suppressing grainy noises due to error diffusion by securing the low grayscale expression and reducing the switching shock and the like.

The typical ones of the inventions disclosed in this application will be briefly described as follows. To achieve the above described objects, the present invention is a display device and a display method in which a signal processing (display driving control) including a subfield conversion processing is performed by using a subfield method based on input picture signals, thereby displaying multi-grayscale moving images on the display panel, and comprises the following technical means.

First, in the subfield method, a field corresponding to a region and a display period of a group of pixels (cells corresponding to pixels) in a display panel is configured by a plurality (N) of subfields with a predetermined weighting of luminance (emission time). Based on an input picture signal, a multi-grayscale moving image is displayed on the display panel by a subfield conversion processing which converts the input picture signal (coding) into data (field and subfield data) of a combination of On/Off state of the plurality (N) of subfields according to the grayscale (signal level of the cell) of the pixels of an object image. In the subfield conversion, the conversion is performed according to a table in which a correspondence relationship between the combination of On/Off of the plurality (N) of subfields and lighting step (step) is defined. The step (s) is associated directly or indirectly with a grayscale value. In the present display device, for example, in a circuit in which the multi-grayscale processing in a circuit unit for the display driving control is performed, the following distinctive processings are performed.

In the present display device, a first means is employed, which controls power by increasing and decreasing the number (N) of subfields (driving object subfields) that configures a field according to the content of a picture. Further, in the present display device, a second means is employed, in which the time for the subfield reduced by the first means is distributed to other driving object subfields so as to control the brightness of the display. By the controls of the first and second means, the power of the screen display is reduced so that brightness (luminance) is increased.

In the present display device, a plurality of selectable (switchable) subfield-converting means and driving means of a corresponding driving sequence are provided. According to a determination on control condition, these converting and driving sequences are selected. In a first class converting means in the plurality of converting means, N is the maximum number (M) as a basic configuration. A second class means is configured to have N being less than the first class converting means (N<M). In other words, from among the configurations of the first class converting, this is a configuration in which particularly a part of the subfields where weighting is small is made to be rest (omitted). A rest SF is Off at all the steps, and is not allowed to exist in the field. Further, a second class conversion is taken as a conversion corresponding to the error diffusion processing. Incidentally, the number (N) of subfields is the same as the number of driving object subfields (subfields having an on-state at some steps) except for the subfields which are made to be off-state at all steps (rest subfields).

Further, in the present display device, means for detecting the distribution situation (histogram) of the grayscale level value of the image, which at least detects the number of pixels of part of the grayscale level is provided. In particular, the number of pixels (p) of low grayscale is detected.

(1) In the present display device, as a control, a conversion (the second class conversion) is selected, which reduces the number (N) of subfields of the field in the first means according to the content and state of the picture, that is, the input picture signal and/or the output signal (data after the subfield conversion). As a result, driving subfields of the field are reduced, and by that much, the power consumption of the display is reduced.

(2) Further, a conversion (third conversion) is selected, which is configured to distribute the time obtained by the subfields reduced in the field (predetermined driving margin period) by the first means to the subfields of the driving object remained in the field so as to prolong the emission time (sustain time) according to each of these weightings. As a result, the emission time is prolonged, and by that much, the brightness (luminance) of the display is increased. The third class conversion is configured not to include a rest time by the rest subfields.

In the present display device, as a picture content, according to the distribution situation of the pixel level of the image, more particularly, according to a determination of threshold value comparison of the number (p) of pixels of low grayscale, one from among the plurality of conversions and driving sequences is selected and driven-displayed. When the low grayscale pixel region is few, the second class conversion having the rest subfields and corresponding driving sequences are selected so as to perform a driving display. Further, a third class conversion may be selected, which is configured to distribute the time for the rest subfields to other subfields. As a result, the low grayscale pixel region of the image is few, and so the power for the display is reduced and the brightness is increased with keeping deterioration of the image few.

(3) Further, in the present display device, in the driving display of the plurality of fields, the plurality of conversions are switched so that the number (N) of subfields and each emission time change according to the picture content.

In the present configuration, when a temporal position of the weighted emission center changes by the switching, during that time, a plurality of transient conversions are used, in which the position and the length of the rest time (idle time) in the field are different. And those conversions are switched step by step so that the change of a position of the temporal weighted emission center (display characteristic) is made as gently as possible. As a result, the switching shock can be mitigated.

The present display device is configured in details as follows, for example. The present display device includes: a means of detecting the number (p) of pixels having less than a predetermined signal level value of a low grayscale side or a predetermined signal level value (L) of a low grayscale side in an image of the input picture signal; a plurality of conversion means for converting the input picture signal into steps depending on a state of lighting/non-lighting of the plurality (N) of subfields per signal level of the pixels according to a predetermined conversion pattern (table); and means of driving a display panel by selecting one from the outputs of the plurality of conversion means and correspondingly selecting one from the plurality of driving sequences including the driving waveforms of the field and the subfield.

The present display device selects the conversion, which increases and reduces the number (N) of subfields according to the picture content and in particular according to the determination of the number of pixels and the like. Particularly, the conversion is selected in such manner that fewer the number (p) of pixels of the low grayscale of the image is, the greater the number of rest subfields at the small side of weighting is. As the control condition, particularly, when the number (p) of pixels in the image is more than a predetermined value, the first class conversion is selected, and when the number (p) of pixels is less than the predetermined value, the second class conversion is selected.

The effects obtained by typical aspects of the present invention will be briefly described below. According to the present invention, relating to a multi-grayscale display device, while preventing deterioration of the image quality of a picture, display (screen) brightness and power of the display are appropriately controlled according to the content of the picture so that both of these performances can be improved. Further, with respect to the prevention of deterioration of the image quality, a technique is provided in which grainy noises due to error diffusion are suppressed particularly by securing the low grayscale expression, and the switching shock and the like can be reduced.

### BRIEF DESCRIPTIONS OF THE DRAWINGS

FIG. 1 is a view showing a block configuration of a display device (PDP device) in an embodiment of the present invention;

FIG. 2 is a view showing an example of panel structure of a display unit (PDP) in the display device of the embodiment of the present invention;

FIG. 3 is a view showing a circuit configuration of one example of a multi-grayscale processing unit in the display device of the embodiment of the present invention;

FIG. 4 is a table of a first SF conversion in a first SF conversion unit in the display device of the embodiment of the present invention;

FIG. 5 is a table of a second SF conversion in a second SF conversion unit in the display device of the embodiment of the present invention;

FIG. 6 is a table of a third SF conversion in a third SF conversion unit in the display device of the embodiment of the present invention;

FIG. 7 is a view showing a configuration example of an error diffusion unit in the multi-grayscale processing unit in the display device of the embodiment of the present invention;

FIG. 8 is a view showing a first configuration example of a pixel number detection unit in the multi-grayscale processing unit in the display device of the embodiment of the present invention;

FIG. 9 is a view showing a second configuration example of a pixel number detection means in the multi-grayscale processing unit in the display device of the embodiment of the present invention;

FIG. 10 is a view showing an output (switching logic) of a switching determination unit in the first configuration of the multi-grayscale processing unit in the display device of the embodiment of the present invention;

FIG. 11 is a view showing a configuration of a driving sequence in the display device of a first embodiment of the present invention;

FIG. 12 is a view showing a configuration of a driving sequence in a display device of a second embodiment of the present invention;

FIG. 13 is a view showing a first configuration of a driving sequence in a display device of a third embodiment of the present invention;

FIG. 14 is a view showing a second configuration of the driving sequence in the display device of the third embodiment of the present invention;

FIG. 15 is a view showing a third configuration of the driving sequence in the display device of the third embodiment of the present invention;

FIG. 16 is a view showing a fourth configuration of the driving sequence in the display device of the third embodiment of the present invention;

FIG. 17 is a view showing an output (switching logic) of a switching determination unit of a multi-grayscale processing unit in a display device of a fourth embodiment of the present invention;

FIG. 18 is a view showing a block configuration of a display device (PDP device) in a fifth embodiment of the present invention;

FIG. 19 is a view showing an output (switching logic) of a switching determination unit of a multi-grayscale processing unit in the display device of the fifth embodiment of the present invention;

FIG. 20 is a view showing a configuration example of a multi-grayscale processing unit in a display device of a sixth embodiment of the present invention; and

FIG. 21 is a view showing a configuration example of an SF pixel number detection unit of the multi-grayscale processing unit in the display device of the sixth embodiment of the present invention.

### DETAILED DESCRIPTIONS OF PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

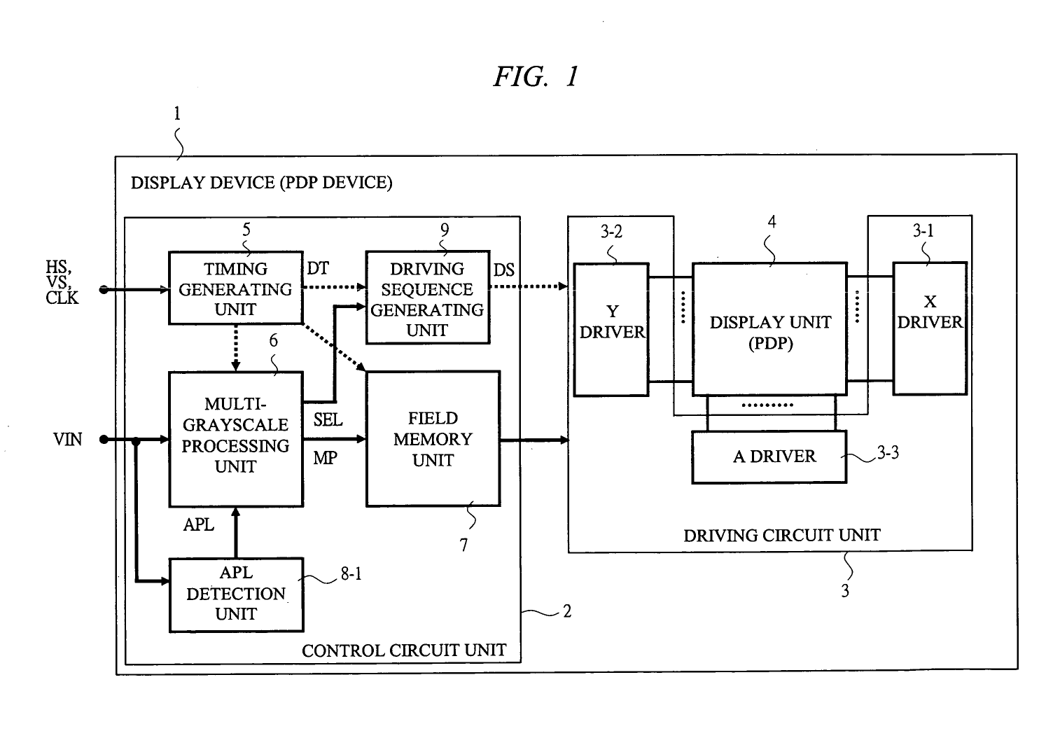

With reference to FIG. 1 to FIG. 11, a first embodiment of the present invention will be described. In the first embodiment, as its feature, in a driving control of a field and a subfield (abbreviated as SF) in a PDP device, a control of switching a plurality of SF conversions different in the number (N) of SFs and the number (s) of steps according to the number (p) of pixels of a signal level of low grayscale of an input image is performed. In this control, by selecting the SF conversion in which the fewer the number (p) of pixels of the low grayscale is, the greater the number of rest SFs is, the power is reduced.

<Display Device>

In FIG. 1, a block configuration of the PDP device which is a display device including multi-grayscale processing means in the first embodiment will be described. The present display device (PDP device) 1 comprises: a control circuit unit 2; a driving circuit unit 3; and a display unit (PDP) 4. The control circuit unit 2 comprises: a timing generating unit 5; a multi-grayscale processing unit 6; a driving-sequence generating unit 9; and a field memory unit 7. Incidentally, in a fourth embodiment described hereinafter, the control circuit unit 2 further comprises an APL detection unit 8-1. The control circuit unit 2 also comprises a signal processing circuit and the like and controls the whole of the display device 1 including the driving circuit unit 3. The driving circuit unit 3 drives the display unit 4 by applying a voltage so as to allow the display unit 4 to display a picture.

The display unit 4 is a display panel formed with a matrix of display cells to correspond with pixels, for example, a PDP of three-electrode AC driving type. The display unit (PDP) 4 comprises an electrode group consisting of a cell group, for example, an X (sustain) electrode, a Y (sustain and scan) electrode, and A (address) electrode.

The driving circuit unit 3 includes an X driver 3-1, a Y driver 3-2, and an A (address) driver 3-3 and the like as various types of drivers corresponding to the electrode group of the display unit (PDP) 4, and they drive respective corresponding electrodes by voltage application.

In the control circuit unit 2, the timing generating unit 5 inputs synchronization signals such as a horizontal synchronization signal: HS, a vertical synchronization signal: VS, a display period signal, a clock signal: CLK, and the like, and generates and outputs a necessary timing signal to control each unit of the multi-grayscale processing unit 6, the field memory unit 7, the driving sequence generating unit 9, and the like.

The multi-grayscale processing unit 6 inputs a digital picture signal (input picture signal or image signal): VIN and performs signal processings (multi-grayscale processing) including the SF conversion processing required to display multi-grayscale moving images on the display unit 4. In the multi-grayscale processing unit 6, to the field memory unit 7, a signal processed data, that is, the field and the SF data (driving control signal): MP is outputted. Further, to the driving sequence generating unit 9, a driving switching determination signal (selection signal): SE to be described below is outputted.

In the field memory unit 7, the output (MP) of the multi-grayscale processing unit 6 is stored once by a unit of field, and at the next field display time, the whole screen (field) image thereof is sequentially outputted to the driving circuit unit 3 per subfield.

The driving sequence generating unit 9 outputs a timing signal DS required to control the driving circuit based on the output DT of the timing generating unit 5 and the output SEL of the multi-grayscale processing unit 6.

The driving circuit unit 3 gets data inputted from the field memory unit 7 and drive-controls a display on the display unit 4. The driving circuit unit 3 selects a driving sequence corresponding to the output (MP) by an output signal (MP) of the multi-grayscale processing unit 6 and its driving switching determination signal (SEL) and drives the display unit 4.

<PDP>

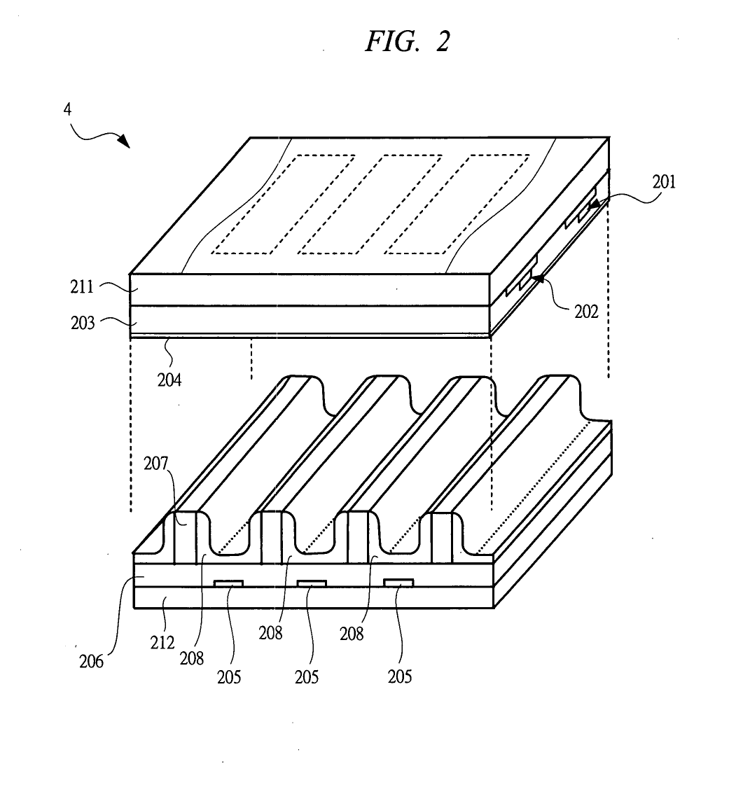

Next, in FIG. 2, a panel structure example (in the case of three-electrode and stripe-shaped rib) of the display unit (PDP) 4 will be described. A part corresponding to the pixel is shown. The present PDP 4 is formed having structures of a front substrate 211 and a back substrate 212 which are mainly formed of luminescent glass and combined facing each other and whose peripheral portion is sealed, and a discharge gas is sealed in spaces thereof.

On the front substrate 211, a plurality of X electrodes 201 and Y electrodes 202 to perform sustain discharges are alternately formed in a longitudinal (column) direction by extending in a horizontal (row) direction in parallel. These electrode groups are covered by a dielectric layer 203 and its surface is further covered by a protective layer 204. On the back substrate 212, a plurality of address (A) electrodes 205 are formed in the longitudinal direction by extending in parallel and further covered by a dielectric layer 206. On the dielectric layer 206, at both sides of the address electrode 205, barrier ribs 207 extending in the longitudinal direction are formed to section in the column direction. Further, on the dielectric layer 206, between the barrier ribs 207, a phosphor 208 is coated, which generates visible light of each color of red (R), green (G), and blue (B) excited by ultraviolet ray.

A row (line) of the display is formed corresponding to a pair of the X electrode 201 and the Y electrode 202, and further, the columns and the cells of the display are formed corresponding to intersections with the address electrode 205. The pixel is formed by a set of cells of R, G, B. A display region of the display unit 4 is formed by a matrix of cells, and is associated with a field and a SF which is a unit of display. Various types of structures of PDP exist according to driving methods and the like.

<Field>

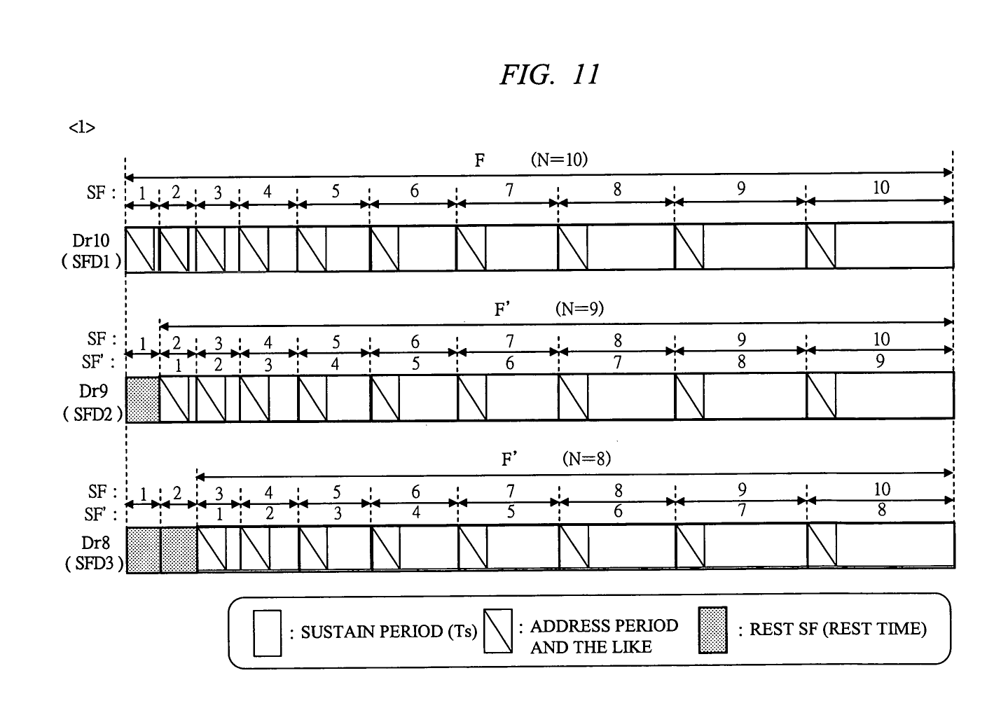

Next, as a basic of the driving control of the display unit (PDP) 4, the driving sequence of the field and the SF will be described (see Dr10 of FIG. 11 described below). One field period (F) is displayed by, for example, 1/60 sec. The field period (F) is formed by a plurality (N) of time-divided SF periods (SF: 1 to N) for grayscale expression. Each SF period has a sustain period (Ts) and a period such as an address period previous to the sustain period. Each SF of the field is weighted by a length of the sustain period (Ts) (the number of sustain discharges), and a combination of On/Off of each SF expresses the grayscales.

In an address period, an addressing is performed, in which cells of On/Off in a cell group of SF are selected. In the next sustain period (Ts), in the selected cells addressed in the previous address period, sustain discharges are performed to the X electrode and the Y electrode, thereby performing an operation to display.

<Multi-Grayscale Processing Unit (1)>

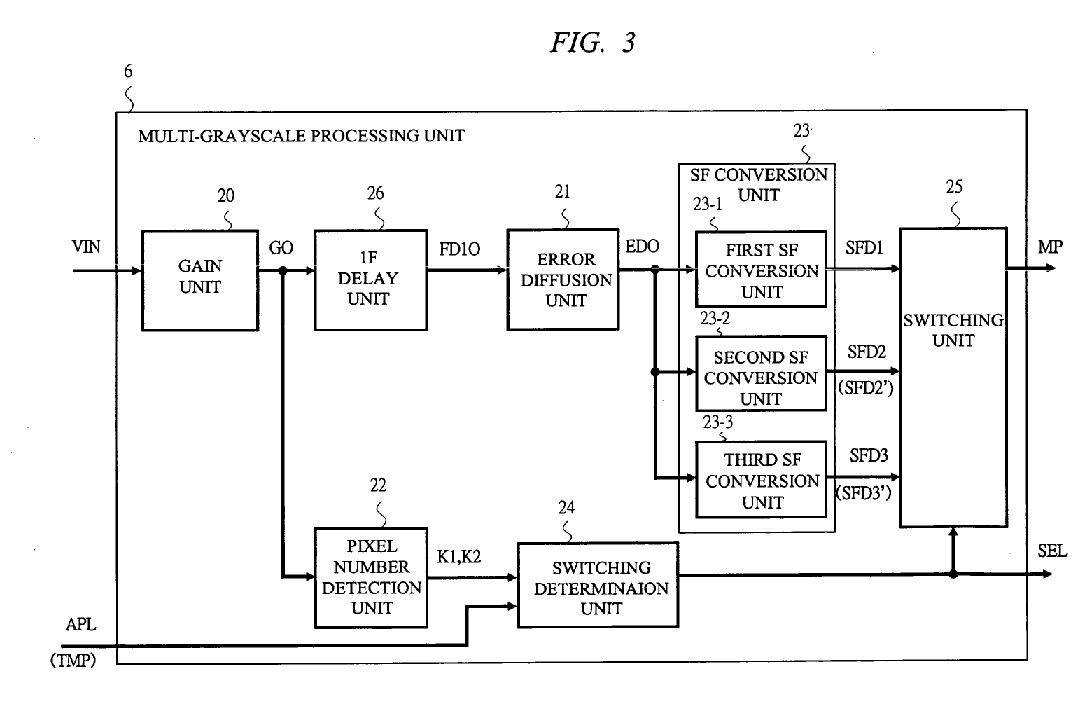

In FIG. 3, one example of a circuit configuration of the multi-grayscale processing unit 6 in the present display device 1 is shown. The multi-grayscale processing unit 6 includes: a gain unit 20; an error diffusion unit 21; a pixel number detection unit 22; an SF conversion unit 23; a switching determination unit 24; a switching unit 25; and a 1F (field) delay unit 26.

In the gain unit 20, a process is performed in which input signals (VIN) are made consistent with the number of conversions (number of steps: S) of the SF conversion unit 23. For example, when the VIN is 10 bit 1024 grayscales and the maximum value of the number of conversions (S) of the plurality of the SF conversion units 23 is 256, the gain unit 20 multiplies the VIN by a gain of 256/1024. When the output of the gain unit 20 is 10 bits, high eight bits are integer, and low two bits are treated as decimal.

The 1F delay unit 26 gets and input of the output: GO of the gain unit 20 and outputs a picture signal: FD1O delayed by one field.

The error diffusion unit 21 is a means of spatially expressing the decimals of the input signal, which gets an input of the output (FD1O) of the 1F delay unit 26 and outputs a signal: EDO. The signal: EDO is a signal whose maximum value is the number of conversions (S) of the SF conversion unit 23.

The pixel number detection unit 22 is a means of detecting distribution situation (histogram) per grayscale in an image corresponding to one field. In the present example, the pixel number detection unit 22 detects and outputs the number of pixels of low grayscale less than a predetermined level.

The SF conversion unit 23 converts (encodes) the calculated picture signal value (EDO) into On/Off signals of the SF according to a SF conversion table. The SF conversion unit 23 comprises a plurality (three) of SF conversion units (23-1, 23-2, 23-3) for different SF conversions, and each SF conversion unit 23 is formed with a lookup table (LUT), that is, an SF conversion table provided respectively.

The switching determination unit 24 gets signals K1 and K2 inputted from the pixel number detection unit 22 to determine switching and outputs a resultant signal (SEL) (APL and the like will be described later). In the switching unit 25, any one from among an output (SFD1) of the first SF conversion unit 23-1, an output (SFD2) of the second SF conversion unit 23-2, and an output (SFD3) of the third SF conversion unit 23-3 is selected by the output signal (SEL) of the switching determination unit 24, and is outputted as a signal (MP).

<SF Conversion>

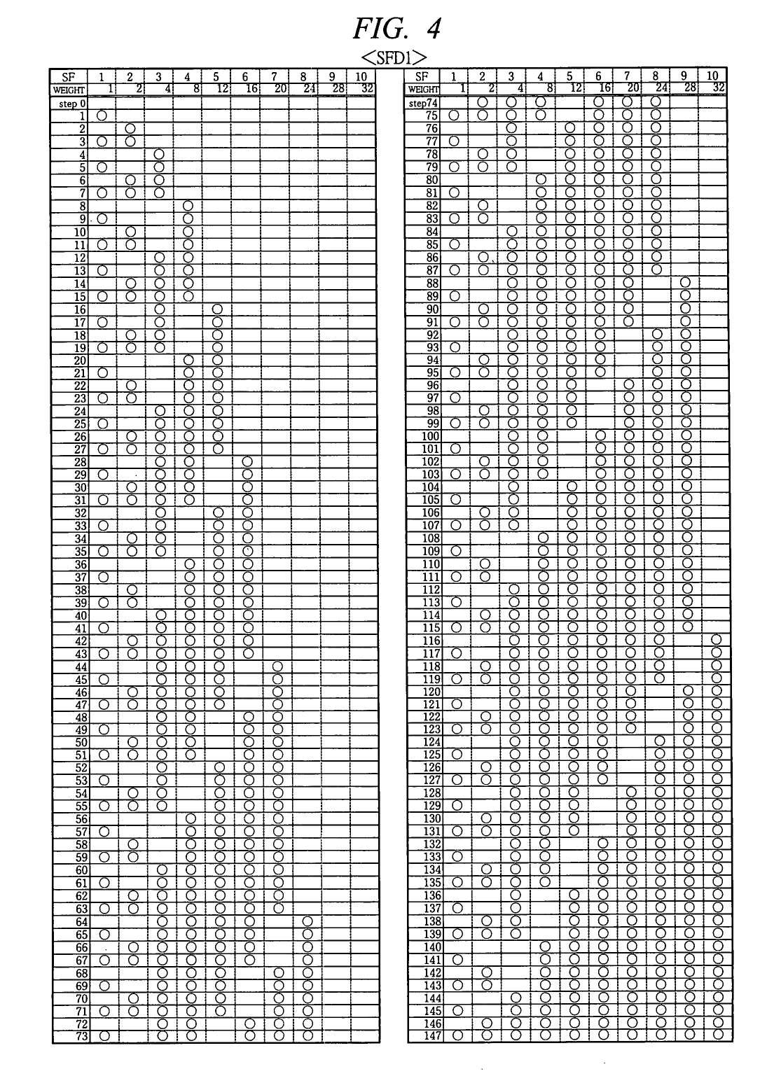

In FIG. 4 to FIG. 6, configuration examples of the SF conversion table (SF lighting pattern table) of the SF conversion unit 23 are shown. The SF conversion table defines a correspondence relationship of a combination of On/Off state (selection lighting) of each SF of the field per step (s: step) associated with the grayscales of the pixels. A round mark indicates an SF place lighted (On), and a blank indicates an SF place non-lighted (Off).

The step (s: step) means a lightening stage obtained by a combination of SF On/Off states and is associated with the grayscale level. The number (N) of SFs in the field is, for example, ten pieces from SF1 to SF10 in the basic configuration (first SF conversion) shown in FIG. 4. The maximum number of the SF is M=10. Each SF is weighted with a predetermined luminance (emission time) sequentially from the lowest level to the highest level, and is shown in a time direction sequentially from the SF (SF1) of the smallest weight in the field. By the pattern of combination of On/Off of these SF groups, a predetermined number of steps (s) are formed, and by using these steps, the predetermined number of grayscales can be expressed. Note that, with respect to the grayscale level not directly expressible by the steps, it is expressed by the known error diffusion processing and the like.

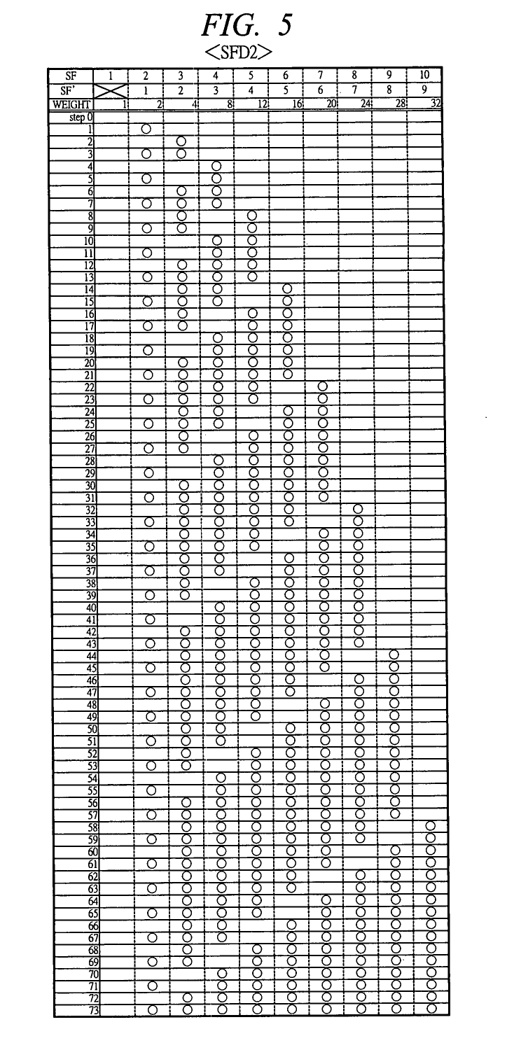

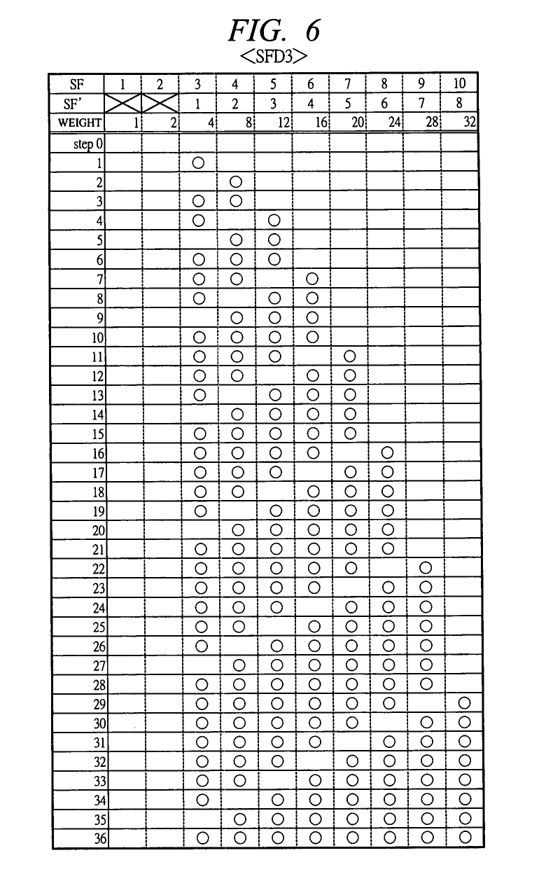

The number (S) of steps in each table of FIG. 4 to FIG. 6 is different, and more specifically, it is 147, 73, and 36 (excluding 0). SFs of N=10 (SF1 to SF10) in the first SF conversion table of FIG. 4 are taken as a basic configuration. In contrast to this table, SF′s (N=9) of a second SF conversion table of FIG. 5 and SF′s (N=8) of a third SF conversion table of FIG. 6 are formed, and the correspondence relationship is shown in each table. In SF′s (SF′1 to SF′9) of the second SF conversion table, SF1 of the first SF conversion is taken as a rest SF, and the phrase “subsequent to SF2” is rephrased as “subsequent to SF′1.” Similarly, in SF″s (SF″1 to SF″8) of the third SF conversion table, SF1 and SF2 of the first SF conversion are taken as rest SFs, and the phrase “subsequent to SF3” is rephrased as “subsequent to SF′1.”

In FIG. 4, a first SF conversion (output: SFD1) of the first SF conversion unit 23-1 is shown. In SFs of N=M=10 from SF1 to SF10 in the field, predetermined weights (1, 2, 4, 8, 12, 16, 20, 24, 28, and 32) are given.

By these On/Off combinations, steps (s) 0 to 147 can be expressed, and luminance ratio becomes such as 1, 2, 3, . . . .

In FIG. 5, a second SF conversion (output: SFD2) of the second SF conversion unit 23-2 is shown. This conversion has SFs of SF2 to SF10 in the field, that is, N=M−1=9 of SF′1 to SF′9, and is given the same weight as the basic configuration except for the rest SF. By these SF′s, steps (s) 0 to 73 can be expressed. In SFD2, with respect to SFD1, SF1 having the smallest weight becomes the rest SF, that is, the SF of Off state (no On place) at all steps (s) and not used. In SFD2, since SF1 is in rest, the luminous ratio is in multiples of 2 such as 2, 4, 6 . . . .

In FIG. 6, a third SF conversion (output: SFD3) of the third SF conversion unit 23-3 is shown. This conversion has SFs of SF3 to SF10 in the field, that is, SF″s of N=M−2=8 of SF″1 to SF″8, and is given the same weight as the basic configuration except for the rest SF. By these SF″s, steps (s) 0 to 36 can be expressed. In SFD3, with respect to SFD1, SF1 of the smallest weight and the next SF2 become the rest SFs. In SFD3, since SF1 and SF2 are in rest, the luminance ratio is in multiples of 4 such as 4, 8, 12, . . . .

<Error Diffusion Unit>

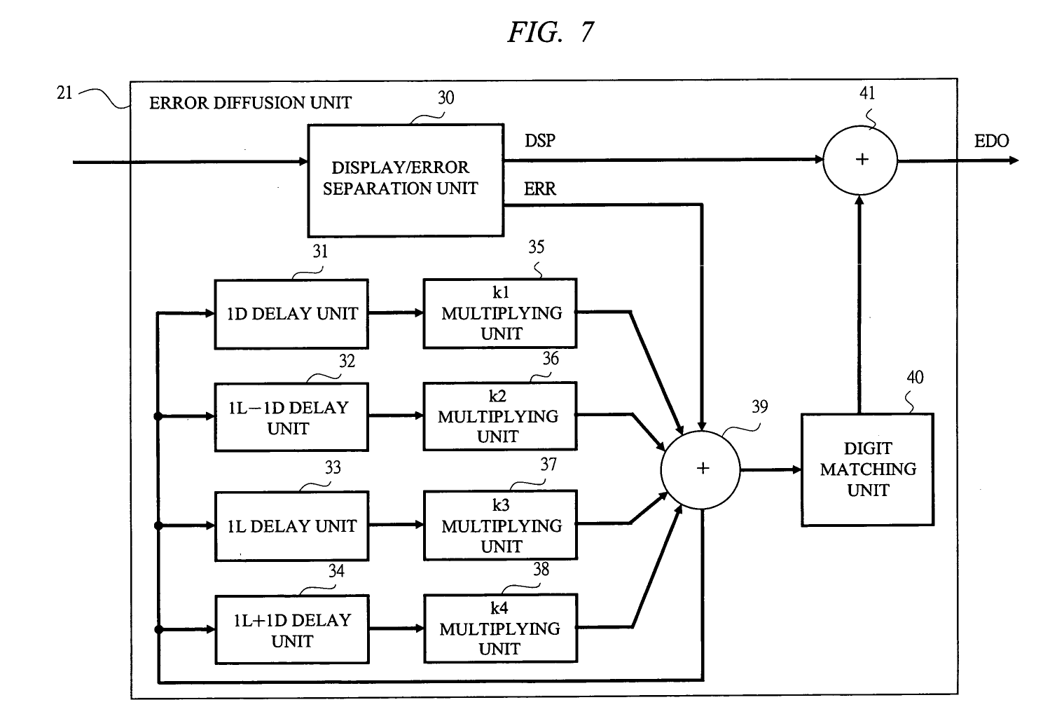

Next, in FIG. 7, one example of circuit configuration of the error diffusion unit 21 is shown. The error diffusion unit 21 has a display/error separating unit 30, a 1-pixel (1D) delay unit 31, a 1-line (1L)−1-pixel (1D) delay unit 32, a 1L delay unit 33, a 1L+1D delay unit 34, a k1 multiplying unit 35, a k2 multiplying unit 36, a k3 multiplying unit 37, a k4 multiplying unit 38, adding units 39 and 41, and a digit matching unit 40, respectively as respective circuit units.

The display/error separating unit 30 separates a display bit (DSP) and a diffusion bit (ERR) of an input. The 1D delay unit 31, the 1L-1D delay unit 32, the 1L delay unit 33, and the 1L+1D delay unit 34 allow input signals to delay by the corresponding amount, respectively. The multiplying circuits (35 to 38) multiply the inputs by each coefficients k1, k2, k3, and k4. The diffusion bit (ERR) and the outputs of the multiplying circuits (35 to 38) are added by the adding unit 39, and are inputted to the digit matching unit 40. The digit matching unit 40 matches a carry-data from the adding unit 39 as a bit for adding to the display bit (DSP). And, matched with the grayscales of the display, the display bit (DSP) separated by the display/error separating unit 30 and the bit outputted by the digit matching unit 40 are added by the adding unit 41, and outputted as a signal (EDO).

<Pixel Number Detection Unit (1-1)>

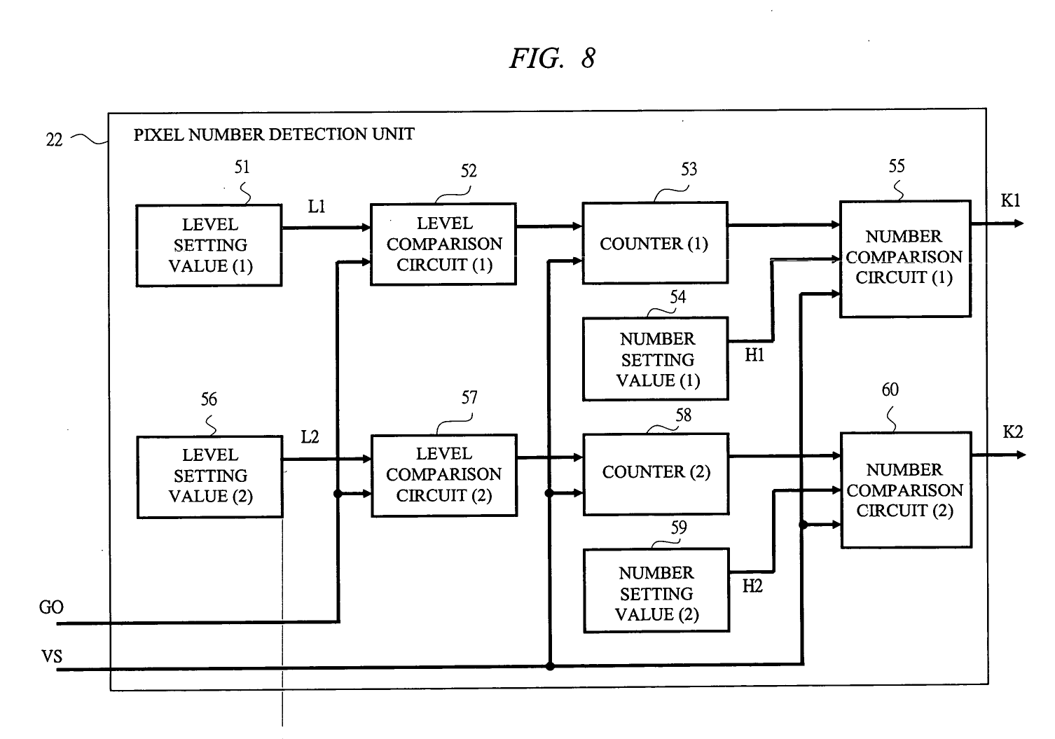

Next, in FIG. 8, a configuration example of the pixel number detection unit 22 is shown. The pixel number detection unit 22 counts the number (p) of pixels with levels less than a level setting value and outputs a result by comparing it for determination with a number setting value. The configuration is such that two-system threshold values are used for switching the three SF conversions of the SF conversion units 23. The pixel number detection unit 22 includes: a level setting value (1) 51; a level setting value (2) 56; a level comparison circuit (1) 52, a level comparison circuit (2) 57; a counter (1) 53, a counter (2) 58; a number setting value (1) 54; a number setting value (2) 59; a number comparison circuit (1) 55; and a number comparison circuit (2) 60.

In the level setting value (1) 51 and the level setting value (2) 56, values (L1 and L2) respectively different in the low grayscales serving as boundary values to count the number (p) of pixels are set. And, for example, “1” is set for the level setting value (1) 51 and “2” is set for the level setting value (2) 56. In the level comparison circuit (1) 52, the level setting value (1) 51 and the signal GO are input so as to compare the values thereof and when the signal GO is smaller, “1” is outputted, and when the signal GO is larger, “0” is outputted. Similarly, the level comparison circuit (2) 57 inputs the level setting value (2) 56 and the signal GO so as to compare the values thereof and when the signal GO is smaller, “1” is outputted, and when the signal GO is larger, “0” is outputted.

In the counter (1) 53, the output of the level comparison circuit (1) 52 and the signal VS are inputted and when the output of the level comparison circuit (1) 52 is “1”, the count value is added (+1). When the output is “0”, the counter value is kept as it is, and when the signal VS gets to show a vertical synchronous period, the count value is reset to “0”. Similarly, the counter (2) 58 performs a count processing for the output of level comparison circuit (2) 57 and the signal VS.

In the number setting value (1) 54 and the number setting value (2) 59, predetermined numerical values (H1 and H2) serving as threshold values of the determination of the number (p) of pixels are set, respectively. These values may be the same value or different values. In the number comparison circuit (1) 55, the output of the counter (1) 53 and the number setting value (1) 54 are inputted and when the signal VS gets to show the vertical synchronous period, the output value of the counter (1) 53 and the value of the number setting value (1) 54 are compared and a signal (numerical value): K1 is outputted. About the output (K1) of the number comparison circuit (1) 55, when the output value of the counter (1) 53 is smaller than the number setting value (1) 54, it is continued to be “0” until the next signal VS gets to show the vertical synchronous period, and when the output value of the counter (1) 53 is larger than the number setting value (1) 54, it is “1”. Also in the number comparison circuit (2) 60, similar to the above, the signal (numerical value): K2 is outputted.

Each setting value (51, 56, 54, and 59) is set in advance or settable by a user.

<Pixel Number Detection Unit (1-2)>

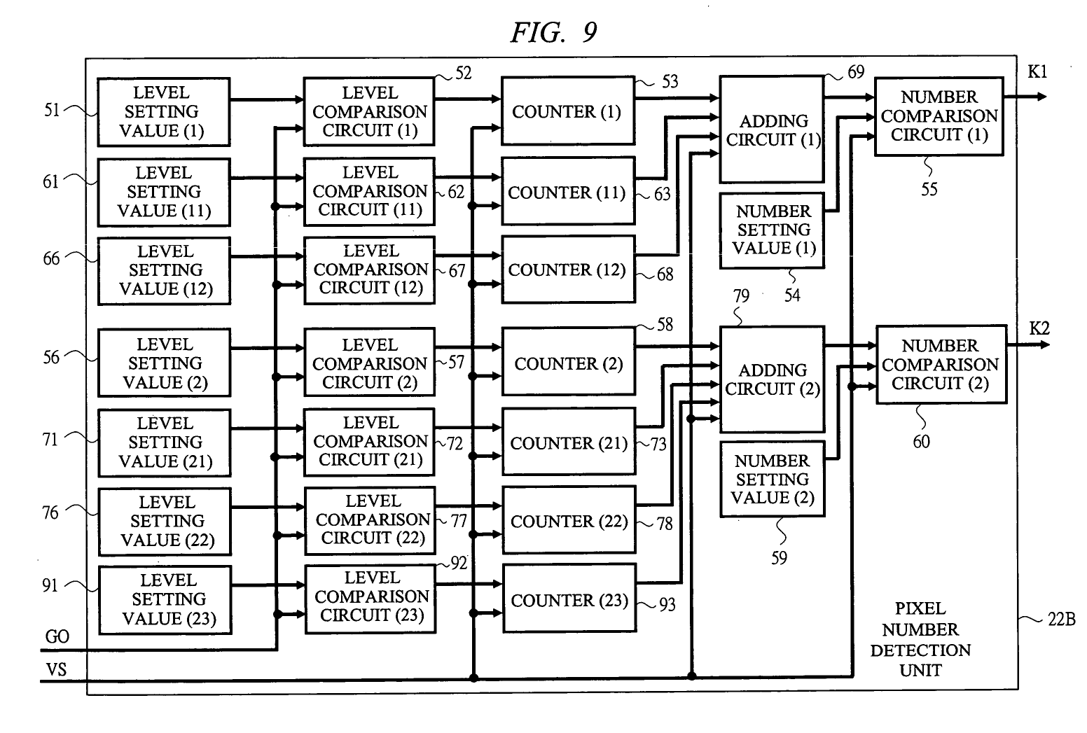

In FIG. 9, a modified example (pixel number detection unit 22B) of the configuration of the pixel number detection unit 22 of FIG. 8 is shown, in which the number of level setting values for control is increased to seven.

In the level setting value (1) 51, a level setting value (11) 61, and a level setting value (12) 66, as a setting value, for example, 1, 3, and 5 are set. These values (1, 3, 5) are values which make SF1 turned on by the first SF conversion (SFD1) of the first SF conversion unit 23-1 in FIG. 4 and contribute to the grayscale expression of the low grayscales. Similarly to the second and third SF conversions (SFD2 and SFD3), when SF1 is turned off (rest SF), it is unable to directly grayscale-express these values (1, 3, 5). Therefore, these values (1, 3, 5) are turned into the level setting values so that more detailed control can be performed.

The level comparison circuit (1) 52, a level comparison circuit (11) 62, and a level comparison circuit (12) 67 perform the same operations. The counter (1) 53, a counter (11) 63, and a counter (12) 68 perform the same operations. An adding circuit (1) 69 gets inputted the outputs of the counter (1) 53, the counter (11) 63, and the counter (12) 68 and adds them up. The number comparison circuit (1) 55 performs the same operation as described in FIG. 8.

In the level setting value (2) 56, a level setting value (21) 71, a level setting value (22) 76, and a level setting value (23) 91 as setting values, for example, 2, 3, 6, and 7 are set. These values (2, 3, 6, 7) are values which make SF2 turned on by the SF conversion (SFD1) of the first SF conversion unit 23-1 of FIG. 4, and contribute to the grayscale expression of the low grayscales. These values are also turned into the level setting values for the same reason, so that more detailed control can be performed.

The level comparison circuit (2) 57, a level comparison circuit (21) 72, a level comparison circuit (22) 77, and a level comparison circuit (23) 92 perform the same operations. The counter (2) 58, a counter (21) 73, a counter (22) 78, and a counter (23) 93 perform the same operations. An adding circuit (2) 79 gets inputted the outputs of the counter (2) 58, the counter (21) 73, the counter (22) 78, and the counter (23) 93 and adds them up. The number comparison circuit (2) 60 performs the same operation as described in FIG. 8.

When the first SF conversion of FIG. 4 is switched to the second SF conversion of FIG. 5, the places where the SF is turned-on such as steps 1, 3, 5, . . . in FIG. 4 disappear, and thus grayscale expression is disabled, and the grayscale expression comes to be performed by alternate steps such as steps 2, 4, 6 . . . . The lower the grayscale is, the more the grayscale expressive power is affected. Therefore, in the configuration of FIG. 9, the low grayscale expression becomes more sensitive (detailed control) than the configuration of FIG. 8. In the configuration of FIG. 9, load ratios of SF1 and SF2 of the low grayscale side are detected.

<Switching Determination (1)>

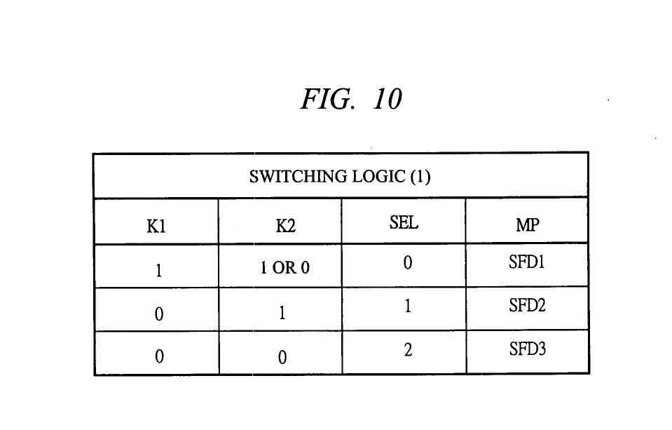

Next, in FIG. 10, the outputs of the switching determination unit 24 of the first embodiment, that is, the control logic of the switching of a plurality of SF conversions is shown. The switching determination unit 24 inputs the signals K1 and K2 from the pixel number detection unit 22 and outputs selection signals (SEL) for the switching unit 25 and the driving circuit unit 3. When K1 is “1”, that is, when both K1 and K2 are “1”, or when K1 is “1” and K2 is “0”, SEL=0 is outputted. Further, when K1 is “0” and K2 is “1”, SEL=1 is outputted, and when both K1 and K2 are “0”, SEL=2 is outputted. The switching unit 25 selects SFD1 when SEL is “0”, SFD2 when SEL is “1” and SFD3 when SEL is “2”, and outputs it as a signal MP.

In the case when SEL=0 (SFD1), the number of steps at the SF conversion unit 23 (the first SF conversion unit 23-1) is 147, and thus this requires 8 bits. Therefore, the integer of the error diffusion unit 21 is made to be 8 bits in conformity with that number. In the case when SEL=1 (SFD2), the number of steps of SF conversion unit 23 (the second SF conversion unit 23-2) is 73, and this requires 7 bits. Therefore, the integer of the error diffusion unit 21 is made to be 7 bits in conformity with that number. In the case when SEL=2 (SFD3), the number of steps of the SF conversion unit 23 (the third SF conversion unit 23-3) is 36 and thus this requires 6 bits. Therefore, the integer of the error diffusion unit 21 is made to be 6 bits in conformity with that number.

<Driving Control (1)>

Next, in FIG. 11, a first configuration of the driving control of a plurality (the number of SFs: N) of SFs of one field in the first embodiment will be described. As respective driving sequences corresponding to SFD1, SFD2, and SFD3, Dr10, Dr9, and Dr8 are shown. Note that, the “driving sequence” means a driving of the whole fields including the driving pulse of each SF in the field. The driving sequence is generated by the driving sequence generating unit 9, and the number of pluses of each SF is also calculated. With the driving sequence (Dr10) corresponding to the first SF conversion (SFD1) of FIG. 4 taken as a basic configuration, N=10 pieces of SFs of the field (F) are taken as “SF1” to “SF10”. In contrast to this, the field and the SFs thereof provided with the rest SFs such as the second and third SF conversions (SFD2 and SFD3) are taken as F′ and SF′.

Dr10 is a driving sequence corresponding to the output (SFD1) at the first SF conversion when SEL=0, and drives all the 10 pieces of SFs from SF1 to SF10. The predetermined driving margin time and the field period are the same, and there is no rest time. Note that, in SF, a blank portion indicates a sustain period (Ts), and a shaded portion indicates an address period other than the sustain period (Ts).

Dr9 is a driving sequence corresponding to the output (SFD2) at the second SF conversion when SEL=1 where the first SF1 is a rest SF (rest time) and drives 9 pieces of SFs from SF2 (SF′1) to SF10 (SF′9) from among the 10 pieces of SFs from SF1 to SF10. Dr8 is a driving sequence corresponding to the output (SFD3) at the third SF conversion when SEL=2 where first two SF1 and SF2 are at rest and drives 8 pieces of SFs from SF3 (SF′1) to SF10 (SF′8) from among the 10 pieces of SFs from SF1 to SF10.

When the driving is switched from Dr10 to Dr9 according to the picture content, the power to drive SF1 can be reduced. Further, when the driving is switched from Dr9 to Dr8, the power to drive SF2 can be reduced.

<Effect (1)>

In the first embodiment, the SF conversions (second and third SF conversions) in which the number (N) of SFs putting SFs with small weight at rest is few for the basic configuration (first SF conversion) is selected according to the number (p) of pixels of the low grayscales of the image of the input picture signal. Consequently, with the deterioration of the image quality kept few, the consumption power of the display can be reduced, while the grainy noise due to the error diffusion is suppressed particularly by securing the low grayscale expression.

### Second Embodiment

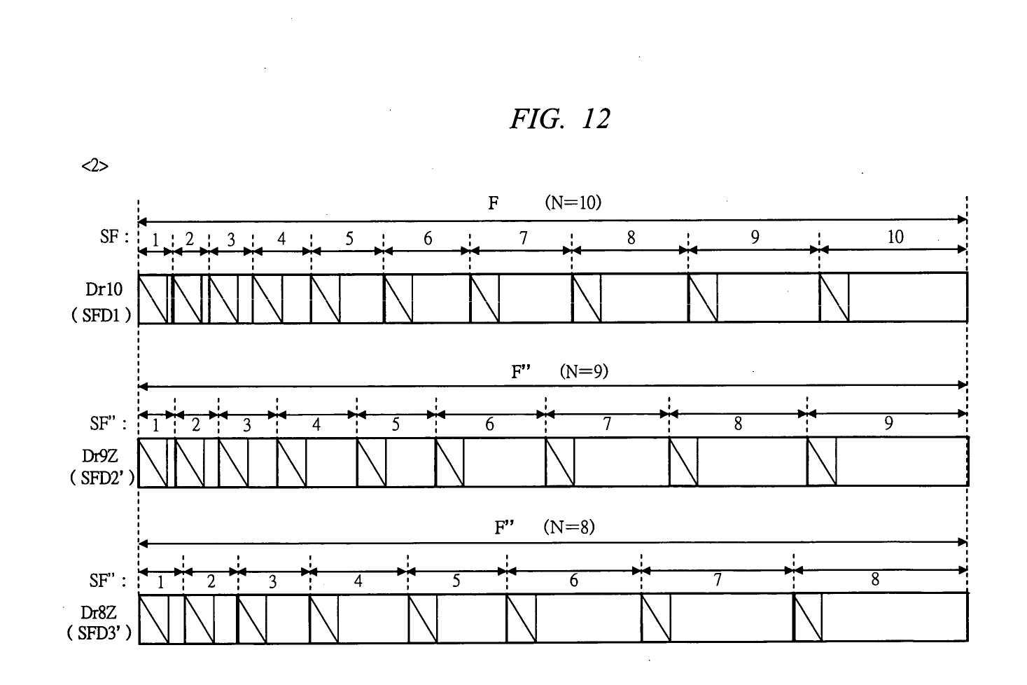

Next, by using FIG. 12, a second embodiment of the present invention will be described. In the second embodiment, in addition to the configuration of the first embodiment in which the SF conversion only for reducing the number (N) of SFs is used, further, an SF conversion in which the rest time by the rest SF portion is distributed to other SFs so as to increase luminance is selected and used. While the configuration of the second embodiment is basically the same as that of the first embodiment, weighting in the conversions (SFD2 and SFD3) by the SF conversion unit 23 is kept as it is, but the number of sustain pulses are different. The number of sustain pulses is calculated by the driving sequence generating unit 9 based on the signal SEL.

<Driving Control (2)>

In FIG. 12, a second configuration of the driving control of a plurality (the number of SF: N) of SFs of one field in the second embodiment is shown. As respective driving sequences corresponding to SFD1, SFD2, and SFD3, Dr10, DR9Z, and Dr8Z are shown. The driving sequence (Dr10) corresponding to the first SF conversion (SFD1) of FIG. 4 is taken as a basic configuration. In contrast to this, similarly to the second and third SF conversions (SFD2 and SFD3), a rest SF is provided, and a field and its SF from which the rest time is distributed to other SFs are taken as F″ and SF″.

Dr9Z is a driving sequence corresponding to the output (SFD2) at a modification of the second conversion when SEL=1. Dr9Z is, in addition to the configuration of Dr9 corresponding to the SFD2, configured to keep the time of one field (F) as it is, and distributes the time of an SF1 portion which is a rest SF to each sustain period (Ts) of 9 pieces of SFs from SF′1 to SF′9 in the same field according to the weighting of each SF, thereby increasing emission luminance. According to the distribution, the number of sustain pulses and the like of each sustain period (Ts) increase little by little.

Dr8Z is a driving sequence corresponding to the output (SFD3) at a modification of the third SF conversion when SEL=2, and is configured to distribute the time of SF1 and SF2 which are two rest SFs to 8 pieces of SFs from SF′1 to SF′8. The length of the field (F″) by these conversions is the same as that of the field (F) of the basic configuration.

When the driving is switched from Dr10 to Dr9Z according to the picture content, by the reduction in the driving of SF1, the luminance of the field is increased by that much. Further, when the driving is switched from Dr9 to Dr8Z, by the reduction in the driving of SF2, the luminance of the filed is increased by that much similarly.

Incidentally, the configurations of the SF conversions in the first embodiment and the second embodiment may be appropriately combined.

<Effect (2)>

In the second embodiment, the time obtained by the rest SF portion in the predetermined driving margin time (field) according to the first embodiment is distributed to the subfields of the remaining driving object so that the performance of the brightness of the display can be improved with the deterioration of the image quality kept few.

### Third Embodiment

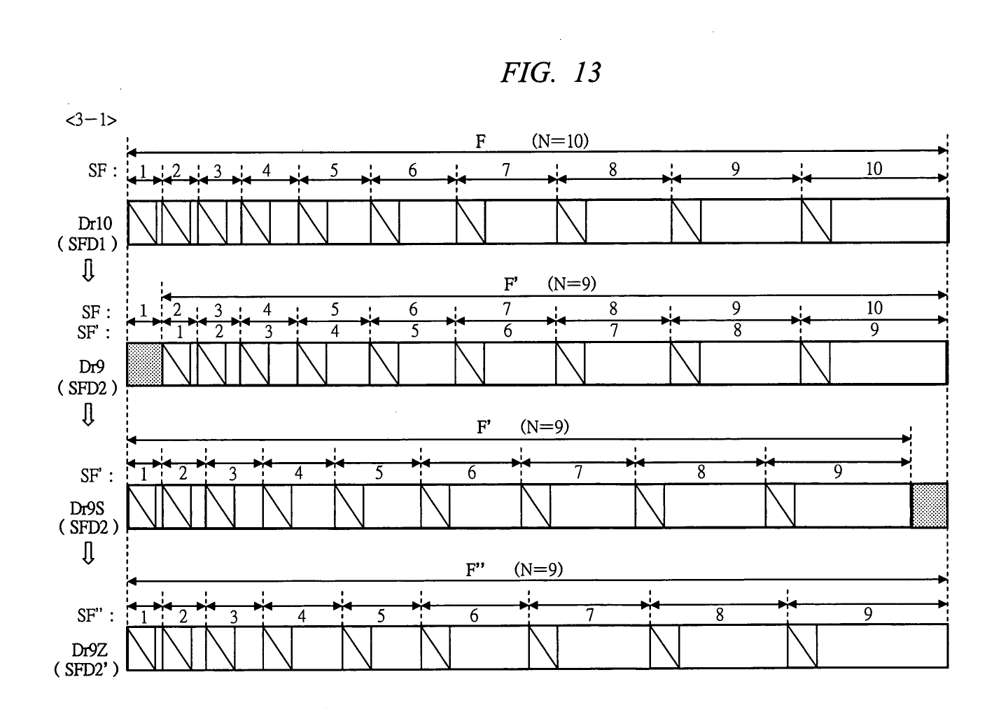

Next, with reference to FIG. 13 to FIG. 16, a third embodiment of the present invention will be described. In the third embodiment, in addition to the switching of a plurality of SF conversions like the first and second embodiments, when a position of the temporal weighted emission center changes by the switching of an SF conversion, a transient conversion (driving sequence) to gently change the position of the weighted emission center during that period is further provided, thereby performing the switching step by step.

<Driving Control (3-1)>

In FIG. 13, a first configuration of a driving control of the third embodiment will be described. Note that, subsequent to the present embodiment, an example is shown in which the switching is made on the configuration (SFD2) in which the number (N) of SFs is 9. This is similar to the configuration (SFD3) in which the number (N) of SFs is 8.

In FIG. 13, a case of switching from Dr10 to Dr9Z is shown. Between Dr10 and Dr9Z, Dr9 and Dr9S are provided. First, a switching is made from Dr10 to Dr9 and further to Dr9S and Dr9Z in order. In the switching from Dr10 to Dr9Z, since the number (N) of SFs is different, the position of the weighted emission center in the time direction changes, and by that much, the switching shock of the picture occurs. Therefore, in the present configuration, by using auxiliary driving sequences (Dr9 and Dr9S) provided between Dr10 and Dr9Z, the switching is performed step by step in the driving of a consecutive field group.

In this manner, the weighted emission center is shifted little by little, thereby alleviating the switching shock. Further, this method of switching can be executed in another method in which the switching is performed in order of Dr10, Dr9 and Dr9Z or in order of Dr10, Dr9S and Dr9Z.

<Driving Control (3-2)>

When the switching is performed from Dr9 to Dr9S of FIG. 13 at once, by that much, the switching shock occurs.

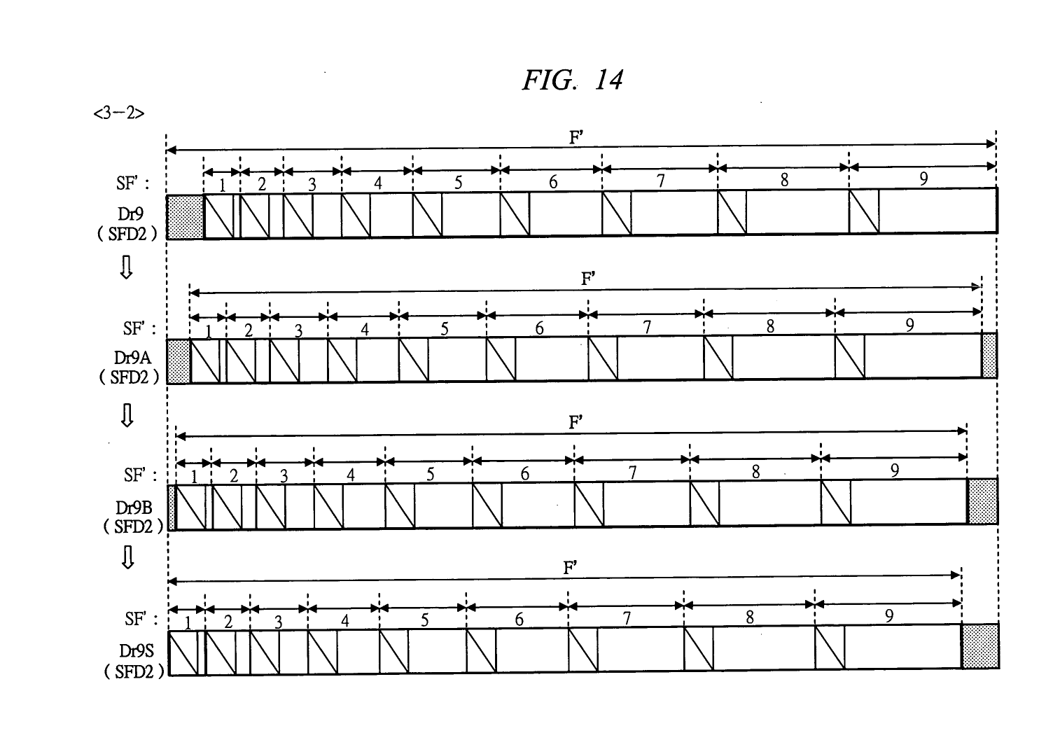

FIG. 14 similarly shows a second configuration of the driving control of the third embodiment. In the present configuration, the switching of a plurality of driving sequences to alleviate switching shock from Dr9 to Dr9S of FIG. 13 is shown. During the period from Dr9 to Dr9S, auxiliary driving sequences (Dr9A and Dr9B) having controlled a length of rest period are provided. While Dr9A is the same in a total length of the rest period as the length of the rest SF (SF1) of Dr9, by dividing the field into a first portion and a last portion, the first portion is provided to be larger. Similarly, while Dr9B is the same in a total length of the rest period as the length of the rest SF (SF1) of Dr9, by dividing the field into a first portion and a last portion, the last portion is provided to be larger. By switching in order of Dr9, Dr9A, Dr9B and Dr9S, the switching shock can be alleviated. Note that, the present configuration is also said to be configured to shift the position of the field (F′) in Dr9A and Dr9B by a constant amount except for the rest period.

<Driving Control (3-3)>

When the switching is performed from Dr9S to Dr9Z of FIG. 13 at once, by that much, the switching shock occurs.

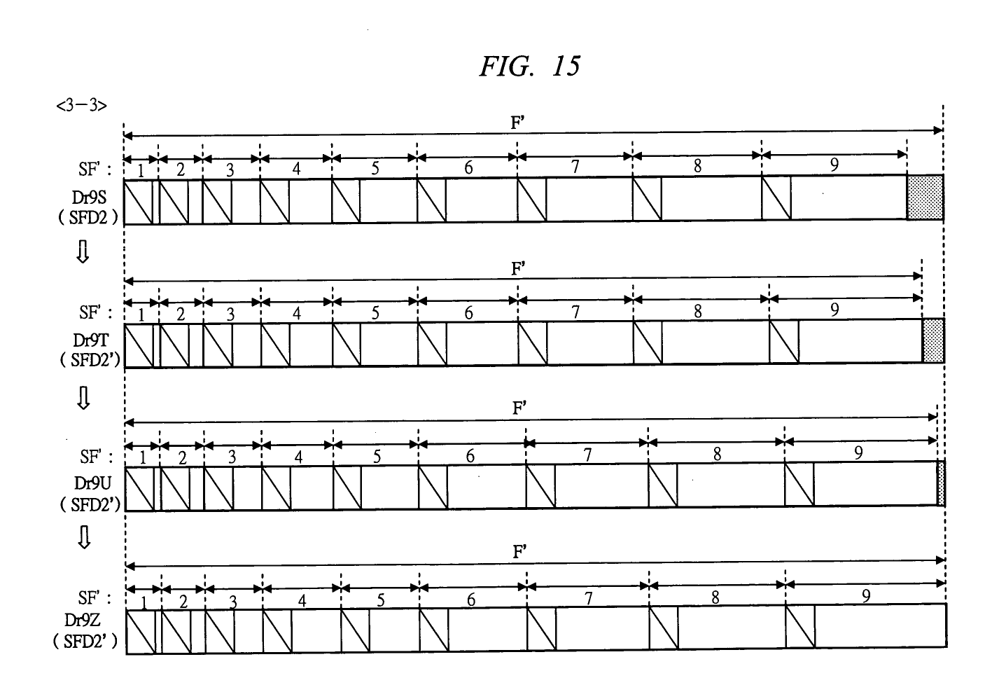

In FIG. 15, a third configuration of the driving control of the third embodiment is shown. In this configuration, the switching of the plurality of driving sequences to alleviate the switching shock from Dr9S to Dr9Z of FIG. 13 is shown. During the period from Dr9S to Dr9Z, auxiliary driving sequences (Dr9T and Dr9U) having simultaneously controlled the lengths of the rest period and a sustain period (Ts) are provided. In Dr9T and Dr9U, a length of the rest period is reduced by a constant amount to the length of the rest SF (SF1) of Dr9S, and correspondingly, the length of each SF′ is configured to increase little by little according to the weight. By switching in order of Dr9S, Dr9T, Dr9U and Dr9Z, the switching shock is alleviated.

<Driving Control (3-4)>

When the switching is performed from Dr9 to Dr9Z of FIG. 13 at once, by that much, the switching shock occurs.

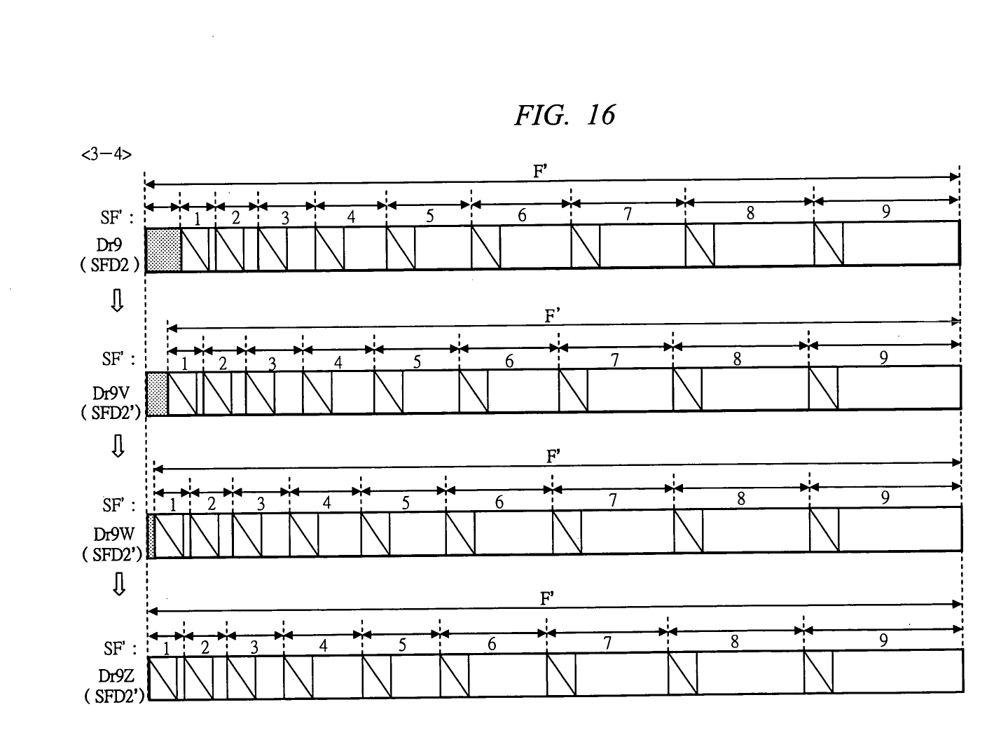

In FIG. 16, a fourth configuration of the driving control of the third embodiment is shown. A switching of a plurality of driving sequences to alleviate the switching shock from Dr9 to Dr9Z of FIG. 13 is shown. Between the period Dr9 and Dr9Z, auxiliary driving sequences (Dr9V and Dr9W) having simultaneously controlled a rest period and a sustain period (Ts) are provided. In Dr9V and Dr9W, a length of the rest period is reduced by a constant amount to the length of the rest SF (SF1) of Dr9, and correspondingly, the length of each SF′ is configured to increase little by little according to the weight. By switching in order of Dr9, Dr9V, Dr9W, and Dr9Z, the switching shock is alleviated.

<Effect (3)>

In the third embodiment, the switching is performed so that the change of the position of temporal weighted emission center (display characteristic) is made to be as gently as possible, thereby alleviating the switching shock and improving image quality.

### Fourth Embodiment

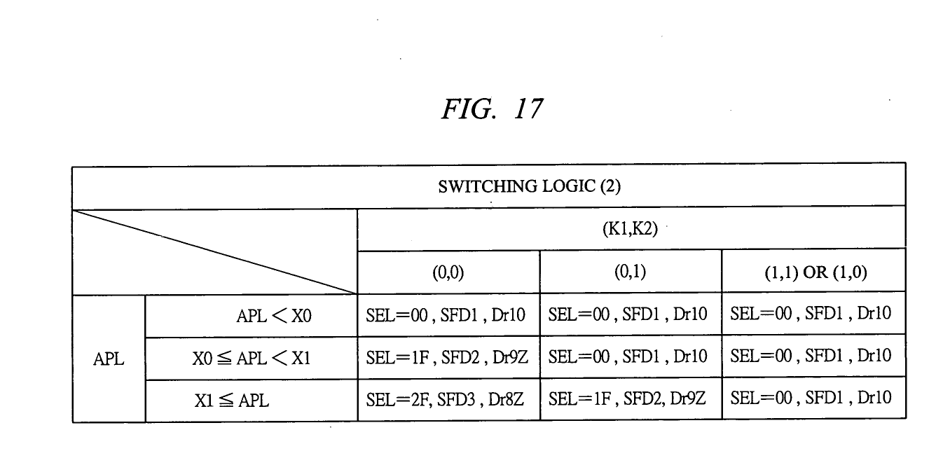

Next, with reference to FIG. 1, FIG. 3, and FIG. 17, a fourth embodiment will be described. In the fourth embodiment, in addition to the same configuration as that of the first embodiment and the like, further, as a control condition, APL is used in addition to the number (p) of pixels of low grayscales so that a control of SF conversion switching is performed.

<Driving Control (4)—APL Detection>

In FIG. 1 described above, as the configuration of the display device 1, a control circuit unit 2 is provided with an APL detection unit 8-1. The APL detection unit 8-1 gets a picture signal (VIN) inputted, and detects an average luminance level (APL: Average Picture Level) per image corresponding to one field as the picture content and outputs its signal (APL) to the multi-grayscale processing unit 6.

Further, in FIG. 3 described above, in the multi-grayscale processing unit 6 of the present display device 1, the inputs of the switching determination unit 24 are three signals of K1, K2, and APL.

<Switching Determination (2)>

FIG. 17 shows outputs of the switching determination unit 24 of the fourth embodiment. The switching determination unit 24 compares and determines an APL value with predetermined values: X0 and X1 (X0<X1). (1) When the APL is less than X0 (APL<X0), that is, a dark picture, regardless of the values of K1 and K2, the switching determination unit 24 outputs SEL=0. At this time, the switching unit 25 selects SFD1, and the output DS of the driving sequence generating unit 9 outputs a timing signal to drive the driving sequence Dr10. (2) When APL is equal to or more than X0 and less than X1 (X0≦APL<X1), that is, when both K1 and K2 are “0” in the picture of an intermediate average luminance, the switching determination unit 24 outputs SEL=1F. At this time, the switching unit 25 selects SFD2, and the output DS of the driving sequence generating unit 9 outputs a timing signal to drive the driving sequence Dr9Z. Further, when both K1 and K2 are not “0”, that is, when a picture of an intermediate average luminance and low grayscales is available, the switching determination unit 24 outputs SEL=00.

At this time, the switching unit 25 selects SFD1, and the output DS of the driving sequence generating unit 9 outputs a timing signal to drive the driving sequence Dr10. (3) When APL is X1 or more (X1≦APL), in case the values of both K1 and K2 are “0”, that is, no bright picture of low grayscales is available, the switching determination unit 24 outputs SEL=2F. At this time, the switching unit 25 selects SFD3, and the output DS of the driving sequence generating unit 9 outputs a timing signal to drive the driving sequence Dr8Z. When K1 is “0” and K2 is “1”, the switching determination unit 24 outputs SEL=1F. At this time, the switching unit 25 selects SFD2, and the output DS of the driving sequence generating unit 9 outputs a timing signal to drive the driving sequence Dr9Z. Further, when K1 is “0” and K2 is “0” or “1”, that is, when a bright and of low grayscale picture is available, the switching determination unit 24 outputs SEL=00. At this time, the switching unit 25 selects SFD1, and the output DS of the driving sequence generating unit 9 outputs a timing signal to drive the driving sequence Dr10.

In other cases, that is, when the number of pictures of low grayscales is large, SEL=0 is outputted.

<Effect (4)>

In the fourth embodiment, the determination is made by using APL, so that the plurality of SF conversions can be more effectively switched.

### Fifth Embodiment

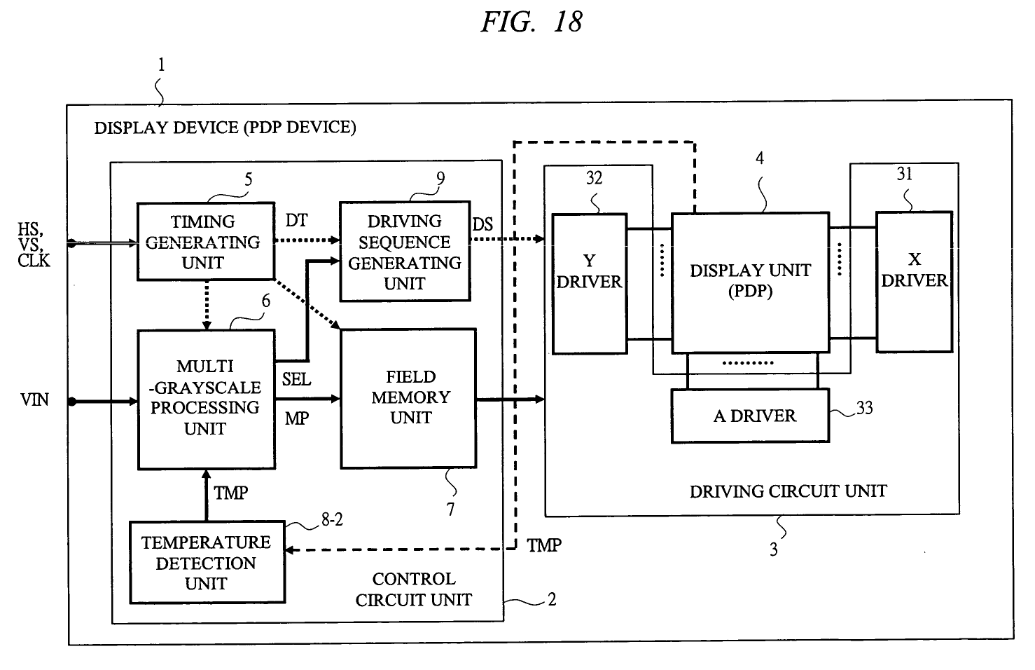

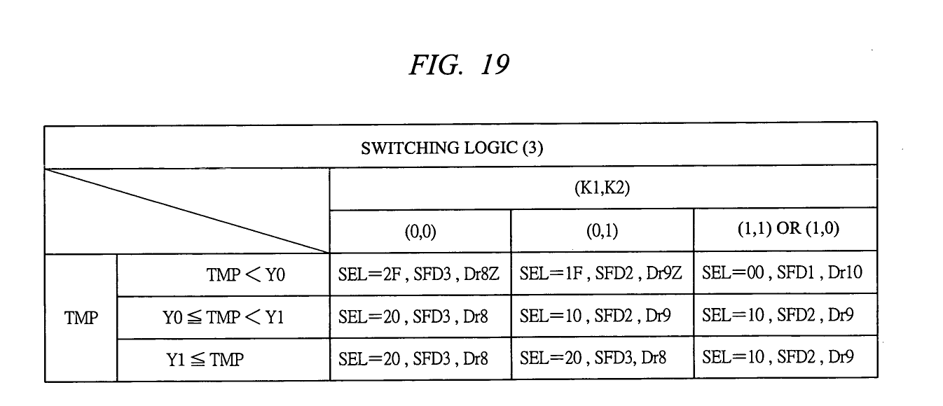

Next, with reference to FIGS. 18 and 19, a fifth embodiment will be described. In the fifth embodiment, in addition to the same configuration as that of the first embodiment and the like, further as a control condition, information (TMP) showing the temperature of the display unit (PDP) 4 in addition to the number (p) of pixels of low scales is used, thereby performing a control of SF conversion switching.

<Driving Control (5)—Temperature Detection>

In FIG. 18, as a configuration of the display device 1 in the fifth embodiment, a temperature detection unit 8-2 is provided. The temperature detection unit 8-2 gets inputted information of the temperature (TMP) of the display unit 4 from the display unit (PDP) 4 and outputs the information (TMP) or processed information to the multi-grayscale processing unit 6. In the multi-grayscale processing unit 6, the switching of a plurality of SF conversions is controlled by using this temperature information (TMP). As the temperature information (TMP), for example, temperature information measured by a temperature sensor provided on a panel surface of the display unit 4 is used.

In FIG. 3 described above, input of the switching determination unit 24 is three signals of K1, K2 and TMP in the multi-grayscale processing unit 6 of the present display device.

<Switching Determination (3)>

FIG. 19 shows outputs of the switching determination unit 24 in the fifth embodiment. The switching determination unit 24 compares and determines a TMP value with predetermined values: Y0 and Y1 (Y0<Y1). (1) When TMP is less than Y0 (TMP<Y0), in case both K1 and K2 are “0”, that is, in case the panel temperature is low and no picture of low grayscale is available, the switching determination unit 24 outputs SEL=2F. At this time, the switching unit 25 selects SFD3, and the output DS of the driving sequence generating unit 9 outputs a timing signal to drive the driving sequence Dr8Z. When K1 is “0” and K2 is “1”, the switching determination unit 24 outputs SEL=1F. At this time, the switching unit 25 selects SFD2, and the output DS of the driving sequence generating unit 9 outputs a timing signal to drive the driving sequence Dr9Z. Further, when K1 is “1” and K2 is “0” or “1”, that is, when the panel temperature is low and a picture of low grayscales is available, the switching determination unit 24 outputs SEL=00. At this time, the switching unit 25 selects SFD1, and the output DS of the driving sequence generating unit 9 outputs a timing signal to drive the driving sequence Dr10. (2) When TMP is equal to or more than Y0 and less than Y1 (Y0≦TMP<Y1), in case both K1 and K2 are “0”, that is, in case the panel temperature is warm and no picture of low grayscales is available, the switching determination unit 24 outputs SEL=20. At this time, the switching unit 25 selects SFD3, and the output DS of the driving sequence generating unit 9 outputs a timing signal to drive the driving sequence Dr8. Further, when both K1 and K2 are not “0”, that is, a picture of low grayscales is available, the switching determination unit 24 outputs SEL=10. At this time, the switching unit 25 selects SFD2, and the output DS of the driving sequence generating unit 9 outputs a timing signal to drive the driving sequence Dr9. (3) When TMP is equal to more than Y1 (Y1≦TMP), in case both K1 and K2 are “0”, that is, in case the panel temperature is warm and no picture of low grayscales is available, the switching determination unit 24 outputs SEL=20. At this time, the switching unit 25 selects SFD3, and the output DS of the driving sequence generating unit 9 outputs a timing signal to drive the driving sequence Dr8. When K1 is “0” and K2 is “1”, the switching determination unit 24 outputs SEL=20. At this time, the switching unit 25 selects SFD3, and the output DS of the driving sequence generating unit 9 outputs a timing signal to drive the driving sequence Dr8. Further, when K1 is “1” and K2 is “0” or “1”, that is, when the panel temperature is warm and the picture of low grayscale is available, the switching determination unit 24 outputs SEL=10. At this time, the switching unit 25 selects SFD2, and the output DS of the driving sequence generating unit 9 outputs a timing signal to drive the driving sequence Dr9.

When the panel temperature is warm, the power consumption by the driving is suppressed without increasing the number of sustains and the temperature increase of the panel is suppressed.

<Effect (5)>

In the fifth embodiment, the determination is made by using the temperature of the display unit 4, so that the plurality of SF conversions can be more effectively switched.

### Sixth Embodiment

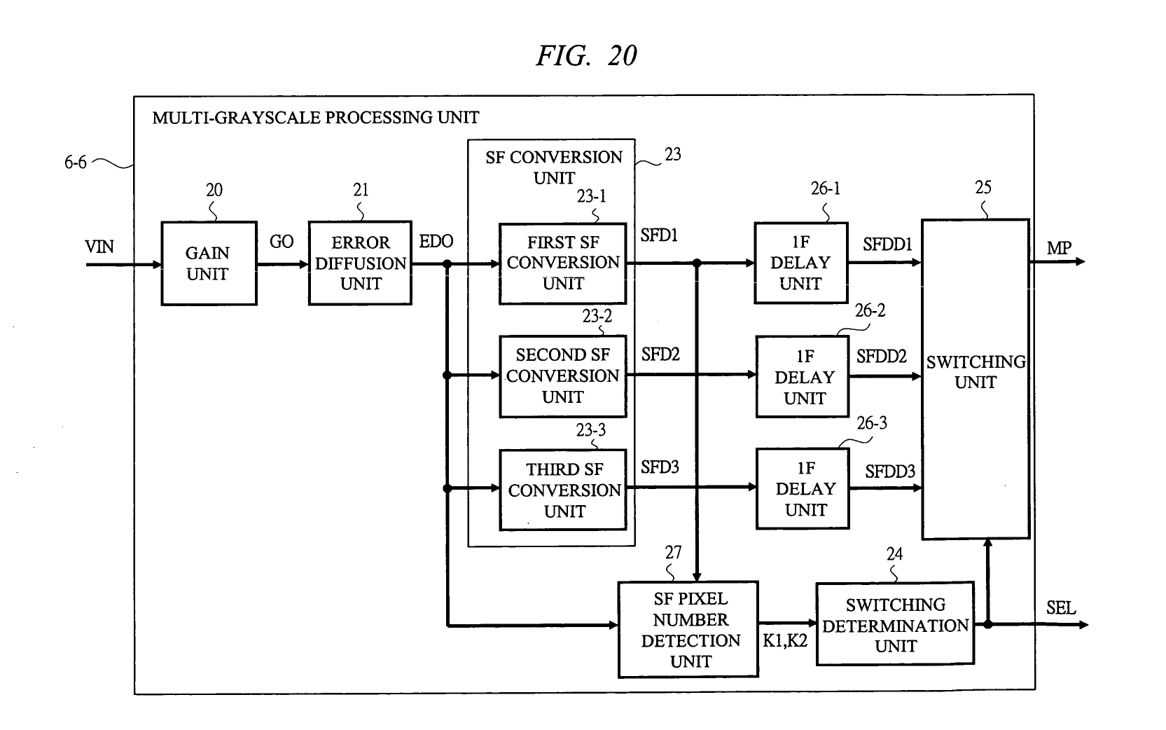

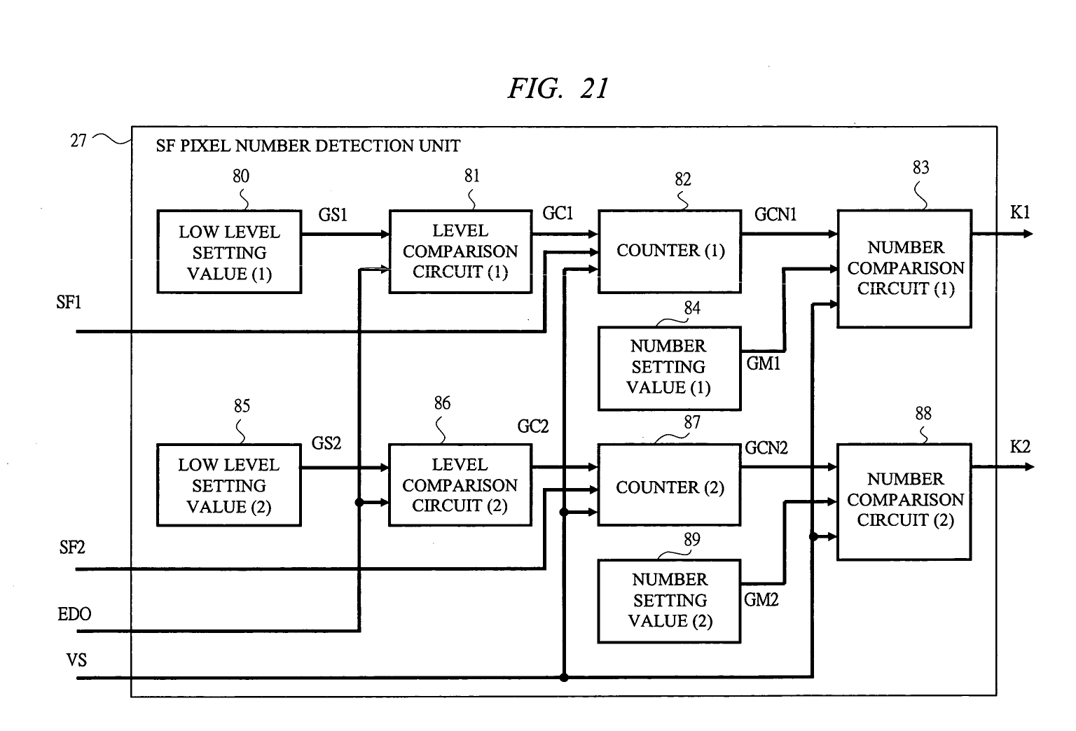

Next, with reference to FIG. 20 and FIG. 21, a sixth embodiment of the present invention will be described. In the sixth embodiment, instead of the input picture signal, SF data after SF conversion is used so as to detect the number of pixels less than a predetermined level. And, by using the detected pixels, a control of SF conversion switching is performed. The number of pixels (corresponding to the number (p) of pixels in the input picture signal in the first embodiment) after the SF conversion is referred to as the number (q) of SF pixels.

<Driving Control (6)—Number of SF Pixels>

In FIG. 20, the configuration of a multi-grayscale processing unit 6-6 of the sixth embodiment provided for the display device 1 is shown. The multi-grayscale processing unit 6-6 has 1F (field) delay units 26 (26-1, 26-2, 26-3) of the subsequent stage of the SF conversion unit 23 and an SF pixel number detection unit 27.

In the 1F delay units 26 (26-1 to 26-3), an output of the first SF conversion unit 23-1: SFD1, an output of the second SF conversion unit 23-2: SFD2, and an output of the third SF conversion unit 23-3 are input: SFD3, are inputted, and signals: SFDD1, SFDD2, and SFDD3 respectively delayed by one field are outputted.

In the SF pixel number detection unit 27, an output of the error diffusion unit 21: EDO and an output of the first SF conversion unit 23-1: SFD1 are inputted, and signals: K1 and K2 having detected and determined the number (q) of SF pixels are outputted. In the SF pixel number detection unit 27, the number (q) of pixels of a part of subfield (SFx) at a side where the predetermined weighting in the field is small is detected as the number (q) of SF pixels. In the switching determination unit 24 and the switching unit 25, the same functions as FIG. 3 described above are performed.

In FIG. 21, a configuration example of the SF pixel number detection unit 27 is shown. The SF pixel number detection unit 27 counts the number (q) of SF pixels less than a low level setting value, compares and determines with the number setting value, and outputs the result thereof. The SF pixel number detection unit 27 includes: a low level setting value (1) 80; a low level setting value (2) 85; a level comparison circuit (1) 81; a level comparison circuit (2) 86; a counter (1) 82, a counter (2) 87; a number comparison circuit (1) 83; a number setting value (1) 84; a number comparison circuit (2) 88; and a number setting value (2) 89.

In the low level setting value (1) 80, a signal: GS1 which is a first low level setting value to be set is outputted. In the low level setting value (2) 85, a signal: GS2 is similarly outputted.

In the level comparison circuit (1) 81, GS1 and SF1 of SFD1 are inputted, and a signal: GC1 is outputted. In the level comparison circuit (1) 81, when the EDO value is GS1 or less, “1” is outputted. In the level comparison circuit (2) 86, GS2 and SF2 of SFD1 are inputted, and a signal: GC2 is outputted. In the level comparison circuit (2) 86, when the EDO value is GS2 or less, “1” is outputted. Note that, in SF1 and SF2, On is “1”, and Off is “0”.

In the counter (1) 82, GC1, SF1, and VS are inputted, and a signal: GCN1 is outputted. The counter (1) 82 sets a counter value to 0 when VS is 0, that is, during a vertical synchronous period, and adds the counter value (+1) when both GC1 and SF1 are 1, that is, when the value of EDO which is the picture signal after error diffusion is the predetermined value GS1 or less and SF1 is 1. Similarly, in the counter (2) 87, GC2, SF2, and VS are inputted, and a signal: GCN2 is outputted. The counter (2) 87 sets a count value to 0 when VS is 0, and adds the count value (+1) when both GC2 and SF2 are 1, that is, when the value of EDO is less than the predetermined value GS2 and SF2 is 1.

In the number setting value (1) 84, a signal (numerical value): GM1 is outputted. In the number setting value (2) 89, a signal (numerical value): GM2 is outputted. In the number comparison circuit (1) 83, VS, GCN1, and GM1 are inputted and K1 is outputted. The number comparison circuit (1) 83, when VS is 0, compares the output: GCN1 of the counter (1) 82 and the output: GM1 of the number setting value (1) 84. And when GCN1 is smaller than GM1, the number comparison circuit (1) 83 outputs 0 for the next one field. In the number comparison circuit (2) 88, VS, GCN2, and GM2 are inputted and K2 is outputted. The number comparison circuit (2) 88, when VS is 0, compares the output of the counter (2) 87: GCN2 and the output of the number setting value (2) 89: GM2 and outputs 0 for the next one field when GCN2 is smaller than GM2.

<Effect (6)>

In the sixth embodiment, the determination is made by using the number (q) of SF pixels, so that the same advantages as those of the first embodiment and the like are obtained. In the case of the sixth embodiment, though the number of field memories (1F delay units 26) increases, the number of pixels per SF can be accurately determined.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A multi-grayscale display method by which a field corresponding to a display region and a display period by a group of pixels in a display panel is configured to be divided into a plurality (N) of subfields weighted by an emission time, and a moving image of multi-grayscale is displayed on the display panel by a conversion to data of lighting/non-lighting of the plurality (N) of subfields according to a grayscale of a pixel based on an input picture signal, which comprising the steps of:
a plurality of conversion steps of converting the input picture image into steps by lighting/non-lighting of the plurality (N) of subfields per a signal level of the pixel according to a predetermined conversion pattern;
a step of selecting one from the plurality of conversion steps and selecting one from a plurality of driving sequences including a driving waveform of the corresponding field and subfield so as to drive the display panel; and
a step of detecting a predetermined signal level value of a low grayscale side in the image of the input picture signal or a number (p) of pixels equal to or less than a predetermined signal level value of a low grayscale side,
wherein the plurality of conversion steps comprise steps as at least two conversion steps different in the number (N) of subfields of:
a first class conversion step in which the number (N) of subfields is a maximum number (M); and
a second class conversion step in which a part of the subfield at a side where weighting is small from among the M pieces of subfields is in a rest so as to make the N smaller than M, and corresponding to an error diffusion processing for spatially enlarging an error by limiting a number of output grayscales,
wherein, when the number (p) of pixels in an image corresponding to the field is equal to or larger than a predetermined value, the first class conversion and a first class driving sequence corresponding thereto are selected, and when the number (p) of pixels is less than the predetermined value, the second class conversion and a second class driving sequence corresponding thereto are selected.

2. The multi-grayscale display method according to claim 1 comprising
a third class driving sequence, in which, with respect to the second class driving sequence in the second class converting step, time obtained by the subfields reduced by the rest in the field is distributed to other subfields in the field so as to prolong an emission time according to each weighting of these subfields,
wherein the third driving sequence is selected instead of the second class driving sequence.

3. A multi-grayscale display apparatus in which a field corresponding to a display region and a display period by a group of pixels in a display panel is configured to be divided into a plurality (N) of subfields weighted by an emission time, and by a conversion to data of lighting/non-lighting of the plurality (N) of subfields according to grayscales of pixel based on an input picture signal, a moving image of multi-grayscale is displayed on the display panel, which comprising:
a plurality of conversion means of converting the input picture image into steps by lighting/non-lighting of the plurality (N) of subfields per a signal level of the pixel according to a predetermined conversion pattern;
a means of selecting one from the plurality of conversion means and selecting one from a plurality of driving sequences including a driving waveform of the corresponding field and subfield so as to drive the display panel; and
a means of detecting a predetermined signal level value of a low grayscale side in the image of the input picture signal or a number (p) of pixels equal to or less than a predetermined signal level value of a low grayscale side,
wherein the plurality of conversion means comprise means as at least two conversion means different in the number (N) of subfields of:
a first class conversion means in which the number (N) of subfields is a maximum number (M); and
a second class conversion means in which a part of the subfield at a side where weighting is small from among the M pieces of subfields is in a rest so as to make the N smaller than M, and corresponding to an error diffusion processing for spatially enlarging an error by limiting a number of output grayscales,
wherein, when the number (p) of pixels in an image corresponding to the field is equal to or larger than a predetermined value, the first class conversion and a first class driving sequence corresponding thereto are selected, and when the number (p) of pixels is less than the predetermined value, the second class conversion and a second class driving sequence corresponding thereto are selected.

4. The multi-grayscale display device according to claim 3 comprising
a third class driving sequence, in which, with respect to the second class driving sequence in the second class converting step, time obtained by the subfields reduced by the rest in the field is distributed to other subfields in the field so as to prolong an emission time according to each weighting of these subfields,
wherein the third driving sequence is selected instead of the second class driving sequence.

5. The multi-grayscale display device according to claim 4
wherein, when the plurality of conversion means are switched so as to change the number (N) of subfields of the field according to the picture in a driving display of a plurality of fields, upon a position of a temporal weighted emission center of field changes by the switching, during that period, a plurality of conversions and driving sequences different in a position or a length of rest time in a field thereof are provided, and these conversions and sequences are switched in order so as to make the change of the position of weighted emission center gentle.

6. The multi-grayscale display device according to claim 4 comprising
a means of detecting an average luminance level (APL) in an image of the input picture signal,
wherein, according to a determination matching the number (p) of pixels with the average luminance level (APL), one is selected from the plurality of conversion means and sequences.

7. The multi-grayscale display device according to claim 4
comprising
means of detecting the average luminance level (APL) in the image of the input picture signal,
wherein a conversion in which the number (N) of subfields is large is selected when the APL is less than a predetermined value;
a conversion in which the number (N) of subfields is large is selected when the APL is equal to or more than a predetermined value and the number (p) of pixels is equal to or more than a predetermined value; and
a conversion in which the number (N) of subfields is small when the APL is equal to or more than a predetermined value and the number (p) of pixels is less than the predetermined value.

8. The multi-grayscale display device according to claim 4
comprising
a means of detecting an average luminance level (APL) in an image of the input picture signal,
wherein a conversion in which the number (N) of subfields is large is selected when the APL is less than a predetermined value;
a conversion in which the number (N) of subfields is large is selected when the APL is equal to or more than a predetermined value and the number (p) of pixels is equal to or more than a predetermined value; and
the second class conversion is selected and the third class driving sequence is selected when the APL is equal to or more than a predetermined value and the number (p) of pixels is less than the predetermined value.

9. The multi-grayscale display device according to claim 4 comprising
a means of detecting a temperature of the display panel,
wherein one is selected from the plurality of conversion means and driving sequences according to a determination matching the number (p) of pixels with the temperature.

10. The multi-grayscale display device according to claim 9,
wherein a conversion in which the number (N) of subfields is large is selected when the temperature of the display panel is less than a predetermined value, and
a conversion in which the number (N) of subfields is small is selected when the temperature is equal to or more than a predetermined value and the number (p) of pixels is less than the predetermined value.

11. A multi-grayscale display device in which a field corresponding to a display region and a display period by a group of pixels in a display panel is configured to be divided into a plurality (N) of subfields weighted by an emission time, and by a conversion to data of lighting/non-lighting of the plurality (N) of subfields according to grayscales of pixel based on an input picture signal, a moving image of multi-grayscale is displayed on the display panel, which comprising:
a plurality of conversion means of converting the input picture image into steps by lighting/non-lighting of the plurality (N) of subfields per a signal level of the pixel according to a predetermined conversion pattern;
a means of selecting one from the plurality of conversion means and selecting one from a plurality of driving sequences including a driving waveform of the corresponding field and subfield so as to drive the display panel; and
a means of detecting a number (q) of pixels of a part of the subfield (SFx) at a side in which a predetermined weighting in the field of an output converted into data of the subfield of the field by the converting means based on the input picture signal,
wherein the plurality of conversion means comprise means as at least two conversion means different in the number (N) of subfields of:
a first class conversion means in which the number (N) of subfields is a maximum number (M); and
a second class conversion means in which a part of the subfield at a side where weighting is small from among the M pieces of subfields is in a rest so as to make the N smaller than M, and corresponding to an error diffusion processing for spatially enlarging an error by limiting a number of output grayscales,
wherein, when the number (q) of pixels of the subfield in the field is equal to or larger than a predetermined value, the first class conversion and a corresponding driving sequence thereof are selected, and when the number (q) of pixels of the subfields is less than the predetermined value, the second conversion and a corresponding driving sequence thereof are selected.
